(19) United States
(12) Patent Application Publication
(10) Pub. No.: US 2024/0165647 A1
(43) Pub. Date: May 23, 2024

(54) PLANAR COMPONENT ASSEMBLY LINE

(71) Applicant: Boxabl Inc., North Las Vegas, NV (US)

(72) Inventors: Paolo Tiramani, Las Vegas, NV (US); Galiano Tiramani, Las Vegas, NV (US); Kyle Denman, North Las Vegas, NV (US); William Schlechter, Las Vegas, NV (US); Christian Kirchen, Las Vegas, NV (US)

(73) Assignee: Boxabl Inc., North Las Vegas, NV (US)

(21) Appl. No.: 18/383,123

(22) Filed: Oct. 24, 2023

Related U.S. Application Data
(60) Provisional application No. 63/426,563, filed on Nov. 18, 2022.

(51) Int. Cl. B05B 13/04

(52) U.S. Cl. CPC B05B 13/04

(57) ABSTRACT

A build-up cell includes a foam assembly ready table for receiving a foam layer, a surface assembly ready table for receiving a first surface panel arrangement, and an assembly bed for receiving a second surface panel arrangement from a first direction and delivering a superposed lamination assembly in a second direction parallel to the first direction. The foam assembly ready table is positioned proximate to the assembly bed on a first side thereof, and the surface assembly ready table positioned proximate to the assembly bed on a second side thereof opposite to the first side thereof. An adhesive gantry straddles the assembly bed and is moveable across the assembly bed in a third direction parallel to the first direction.

### CROSS-REFERENCE TO RELATED APPLICATIONS

This application claims the benefit of U.S. Provisional Patent Application No. 63/426,563, which was filed on Nov. 18, 2022. The entire content of the foregoing provisional application is incorporated herein by reference.

### FIELD OF THE INVENTION

The inventions herein relate to structures, such as dwellings and other buildings for residential occupancy, commercial occupancy and/or material storage, and to components for such structures, including components for panelized systems of construction.

### BACKGROUND

### Description of the Related Art

In the field of residential housing, the traditional technique for building homes is referred to as “stick-built” construction, where a builder constructs housing at the intended location using in substantial part raw materials such as wooden boards, plywood panels, and steel columns. The materials are assembled piece by piece over a previously prepared portion of ground, for example, a poured concrete slab or a poured concrete or cinder block foundation.

There have been a variety of efforts to depart from the conventional construction techniques used to create dwellings, as well as commercial spaces and like, in an effort to reduce costs. In this regard, significant advancements are embodied in the Boxabl® foldable transportable dwelling unit, which consists of a number of enclosure components (four wall components, a floor component and a roof component), and portions thereof, which are dimensioned, positioned and folded together to form a compact shipping module 15, as shown in FIG. 1A. The enclosure components and enclosure component portions are dimensioned so that the shipping module 15 is within applicable highway dimensional restrictions. As a result, shipping module 15 can be transported over a limited access highway more easily, and with appropriate trailering equipment, transported without the need for oversize load permits. Thus, the basic components of structure 150 can be manufactured in a factory, positioned and joined together to form the shipping module 15, and the modules 15 can then be transported to the desired site for the structure, where they can be readily deployed (unfolded) to yield a relatively finished structure 150, which is shown in FIG. 1B.

The use of factory manufacturing also has the potential to reduce the cost of dwellings and like structures. For example, moving from stick-built construction to assembly line manufacturing can advantageously reduce both assembly time and labor costs, particularly when coupled with components designed for assembly line use.

### SUMMARY OF THE INVENTION

The present invention constitutes an advancement in enclosure component manufacturing that reduces the time and personnel necessary to manufacture the floors, roofs, exterior walls and interior walls of a folded, transportable dwelling from their constituent elements, as well as improves the dimensional accuracy of the floors, roofs and walls.

In one aspect, the present invention is directed to a build-up cell comprising a rectangular foam assembly ready table for receiving a foam layer assembly, a rectangular surface assembly ready table for receiving a first surface panel arrangement, and a rectangular assembly bed for receiving a second surface panel arrangement from a first direction and delivering a superposed lamination assembly in a second direction parallel to the first direction. The foam assembly ready table is positioned proximate to the assembly bed on a first side thereof, and the surface assembly ready table is positioned proximate to the assembly bed on a second side thereof opposite to the first side thereof. There is provided an adhesive gantry straddling the assembly bed and moveable across the assembly bed in a third direction parallel to the first direction. There is also provided a first lifter moveable in the horizontal direction between a first position above the foam assembly ready table and a second position above the assembly bed, and moveable in the vertical direction, to thereby engage a foam layer assembly on the foam assembly ready table and lift it to the first position, move it from the first position to the second position, and place it on a second surface panel arrangement on the assembly bed. There is further provided a second lifter moveable in the horizontal direction between a third position above the surface assembly ready table and a fourth position above the assembly bed, and moveable in the vertical direction, to thereby engage a first surface panel arrangement on the surface assembly table and lift it to the third position, move it from the third position to the fourth position, and place it on a foam layer positioned on the assembly bed.

The first and second directions can be colinear. The second and fourth positions can be the same. The first lifter can be linearly moveable in the horizontal direction between the first position above the foam assembly ready table and the second position above the assembly bed. The second lifter can be linearly moveable in the horizontal direction between the third position above the foam assembly ready table and the fourth position above the assembly bed. The rectangular panel assembly ready table can include rollers for can include of the first surface panel arrangement thereon. The rectangular assembly bed includes rollers for movement of the second surface panel arrangement thereon.

The adhesive gantry can include downward-directed nozzles. The downward-directed nozzles can be configured to deposit an extrusion of adhesive onto items placed on the assembly bed. The adhesive can be water activated polyurethane construction adhesive. The adhesive gantry can include water misters configured to spray a mist to activate the extruded adhesive. The first lifter can be a vacuum lifter, a mechanical lifter, or a combination thereon. The second lifter can be a vacuum lifter, a mechanical lifter, or a combination thereof. The build-up cell can include a press table.

These and other aspects of the present inventions are described in the drawings annexed hereto, and in the description of the preferred embodiments and claims set forth below.

### BRIEF DESCRIPTION OF THE DRAWINGS

FIG. 1A is a perspective view of a folded building structure (a shipping module), and FIG. 1B is a perspective view of an unfolded building structure.

FIG. 2 is a top schematic view of the structure shown in FIG. 1B.

FIG. 3 is an end view of a shipping module as shown in FIG. 1A, from which is formed the structure shown in FIG. 1B.

FIG. 4 is an exploded side view of the laminate structure design of the present inventions.

FIG. 5 is an exploded perspective view of an component workpiece of the present inventions.

FIG. 6 is a cutaway perspective view of the core layer of the present inventions.

FIG. 7 is a perspective view of an component workpiece of the present invention at one stage of being manufactured to form a wall component.

FIG. 8 is a perspective view of an enclosure component showing a cutaway of the core layer of two workpieces used to form the enclosure component of the present inventions.

FIG. 9A is a perspective view of a foldable I-beam for a floor component in accordance with the present inventions, in the beam unfolded position, and FIG. 9B is a side view of a foldable I-beam for a floor component in accordance with the present inventions, in the beam folded position.

FIG. 10 is a cutaway perspective view showing the placement of floor end hinge assemblies in the structure of a floor component in accordance with the present inventions.

FIG. 11A is a perspective view of a foldable I-beam for a roof component in accordance with the present inventions, in the beam unfolded position, and FIG. 11B is a side view of a foldable I-beam for a roof component in accordance with the present inventions, in the beam folded position.

FIG. 12 is a cutaway perspective view showing the placement of roof end hinge assemblies in the structure of a roof component in accordance with the present inventions.

FIG. 13 is perspective view providing a schematic illustration of the assembly of the major portions of a floor component of the present inventions.

FIG. 14 is perspective view providing a schematic illustration of the assembly of the major portions of a roof component of the present inventions.

FIG. 15A is a perspective view of a joinder spline of the present inventions, and FIG. 15B is a detailed perspective view of the barbs optionally provided on one or more joinder splines of the present inventions.

FIG. 16A is a perspective view of a facility for the manufacture of enclosure components, and FIG. 16B is a perspective view of a build-up cell which is a portion of that facility.

FIGS. 17A, 17B and 17C are respectively perspective, side and top cutaway views of a fixed space portion of a structure in accordance with the present inventions.

### DETAILED DESCRIPTION OF THE PREFERRED EMBODIMENTS

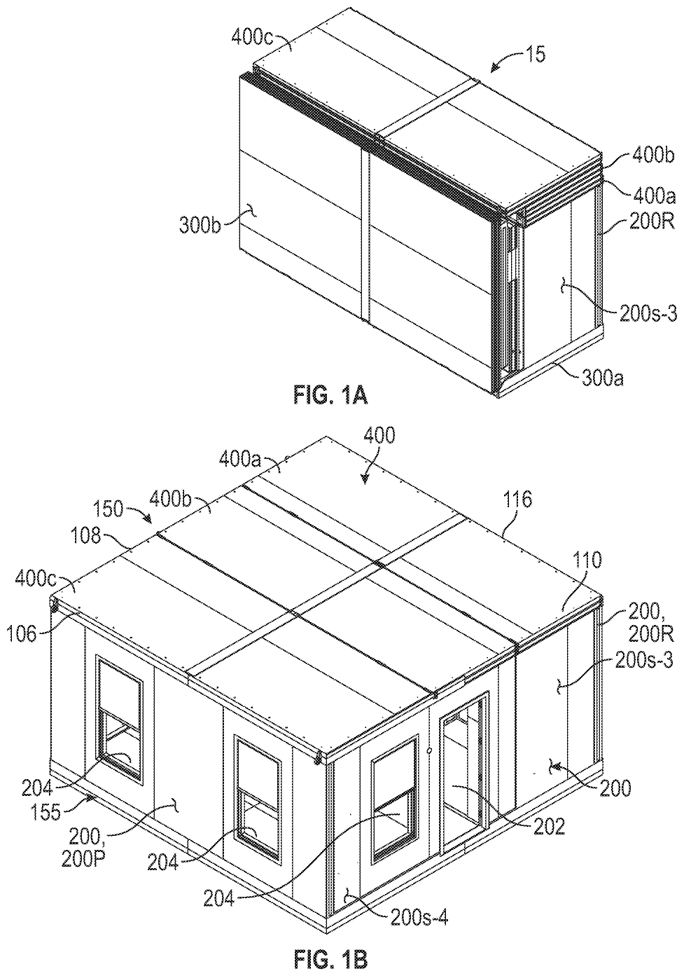

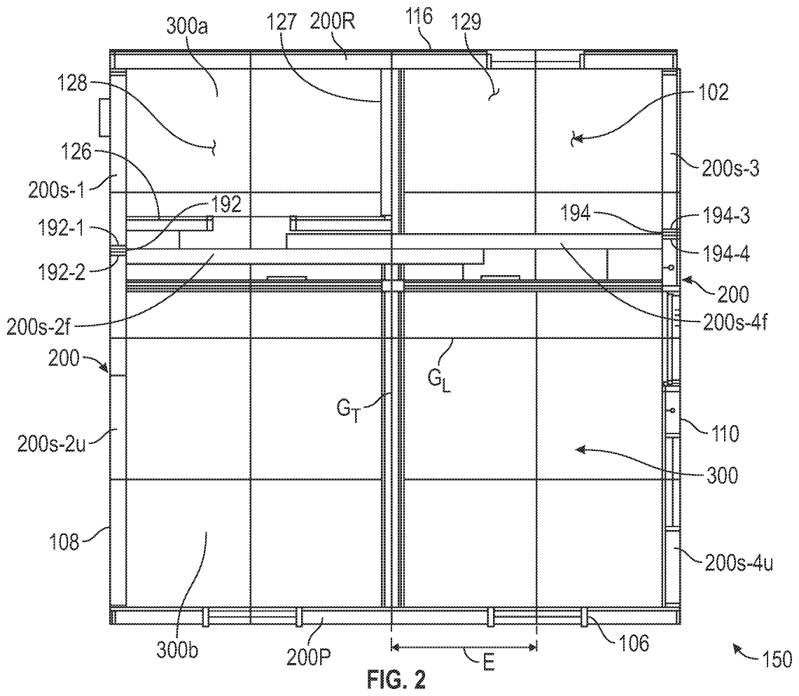

An embodiment of the foldable, transportable structure 150 that is a product of the inventions disclosed herein is depicted in FIGS. 1A through 3. When fully unfolded, as exemplified by FIG. 1B, structure 150 has a rectangular shape made of three types of generally planar and rectangular enclosure components 155, the three types of enclosure components 155 consisting of a wall component 200, a floor component 300, and a roof component 400. As shown in FIGS. 1B and 2, the perimeter of structure 150 is defined by first longitudinal edge 106, first transverse edge 108, second longitudinal edge 116 and second transverse edge 110. For convenience, a direction parallel to first longitudinal edge 106 and second longitudinal edge 116 may be referred to as the “longitudinal” direction, a direction parallel to first transverse edge 108 and second transverse edge 110 may be referred to as the “transverse” direction; and a direction parallel to the vertical direction in FIG. 1B may be referred to as the “vertical” direction. Structure 150 as shown has one floor component 300, one roof component 400 and four wall components 200; although it should be understood that the present inventions are applicable to structures having other configurations as well. The embodiment of structure 150 shown in FIG. 1B is square in shape, approximately 19 feet (5.79 m) by 19 feet (5.79 m), although embodiments of the structure 150 can have different dimensions.

FIG. 2 shows a top schematic view of structure 150 shown in FIG. 1B, and includes a geometrical orthogonal grid, which is used to assist in the lay-out and assembly of the elements forming structure 150, as well as for clarity of explaining the dimensional relationships among its enclosure components 155. The basic length used for dimensioning is indicated as “E” in FIG. 2; the orthogonal grid overlaid in FIG. 2 is 4 E long and 4 E wide; notably, the entire structure 150 preferably is bounded by this 4 E by 4 E orthogonal grid, with the mid-point grid line in the longitudinal direction designated as G_{L} and the mid-point grid line in the transverse direction designated as G_{T} (in this disclosure, reference simply to grid line “G” should be understood to refer to either). In the embodiment of structure 150 shown in FIG. 2, dimension “E” is 57 inches (144.8 cm), although embodiments of the structure 150 can have different “E” dimensions. The use of this grid system will be described further below.

### Enclosure Component (155): General Description

The enclosure components 155 of the present invention include a number of shared design features that are described below.

A. Laminate Structure Design

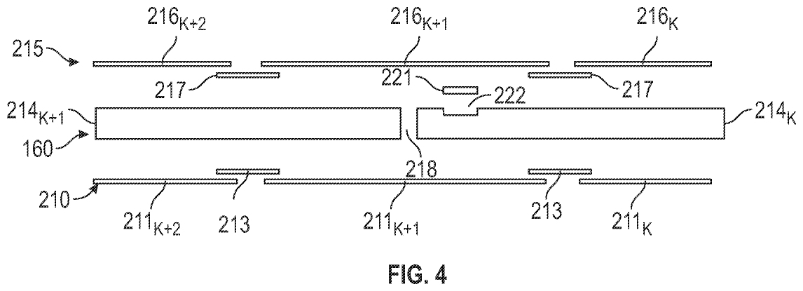

Enclosure components 155 can be fabricated using a multi-layered, laminate design generally shown in FIG. 4. The elements of this multi-layered, laminate design comprise a core layer 160, a first surface layer 210 and a second surface layer 215.

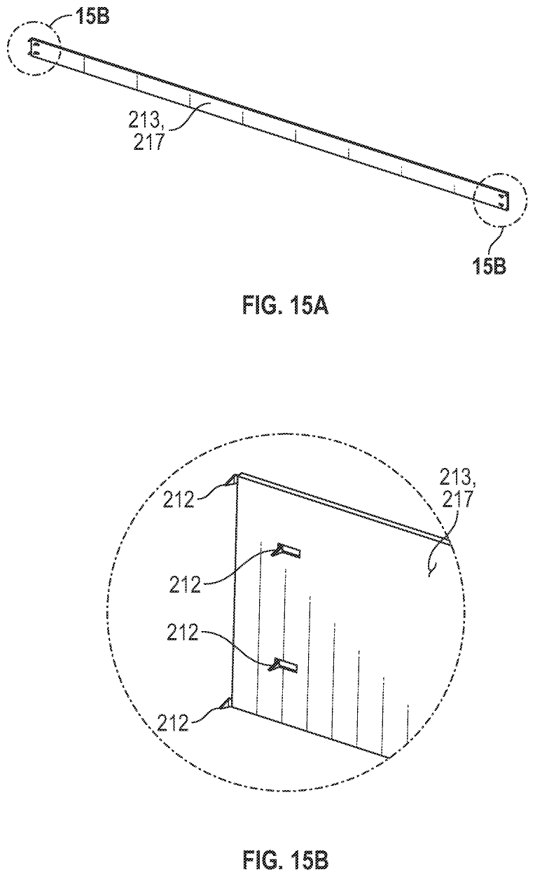

First surface layer 210 comprises two or more planar rectangular first surface panels 211, m in number, where the ith first surface panel 211 is represented by 211ᵢ, and i=1, 2, . . . m. In the case where i≥2, m number of first surface panels 211 are arranged in a side-by-side, contacting relationship (first surface panel 211ₖ, first surface panel 211ₖ₊₁, where 1<k≤m) to form a first surface layer 210 of arbitrary length. An elongate planar rectangular joinder spline 213 overlaps the kth first surface panel 211ₖ and the adjacent k+1th surface panel 211ₖ₊₁. Joinder spline 213 is shown in FIG. 15A. Each joinder spline 213 underlies a narrow portion of each of the adjacent first surface panels 211ₖ, 211ₖ₊₁. First surface panels 211 can be for example fiber cement board or magnesium oxide (MgO) board. The joinder splines 213 can be steel strip stock. Joinder splines 213 can be fastened to first surface panels 211 by adhesive, mechanical fasteners or a combination thereof.

Second surface layer 215 has a construction similar to first surface layer 210. In particular, second surface layer 215 comprises two or more planar rectangular second surface panels 216, n in number, where the ith second surface panel 215 is represented by 215ᵢ, and i=1, 2, . . . n. In the case where i≥2, n number of second surface panels 216 are arranged in a side-by-side, contacting relationship (second surface panel 216ₖ, second surface panel 216ₖ₊₁, where 1<k≤n) to form a second surface layer 215 of arbitrary length. An elongate planar rectangular joinder spline 217 overlaps the kth second surface panel 216ₖ and the adjacent k+1th second surface panel 216ₖ₊₁. Joinder spline 217 in the described embodiment is the same as joinder spline 213 (but need not be), and is also shown in FIG. 15A. Each joinder spline 217 underlies a narrow portion of each of the adjacent second surface panels 216ₖ, 216ₖ₊₁. Second surface panels 216 can be for example fiber cement board or magnesium oxide (MgO) board. The joinder splines 217 can be steel strip stock. Joinder splines 217 can be fastened to second surface panels 216 by a suitable adhesive, preferably a polyurethane based construction adhesive, by mechanical fasteners, or by a combination thereof.

Core layer 160 is sandwiched between first surface layer 210 and second surface layer 215. Core layer 160 comprises a plurality of generally planar rectangular foam panels 214, p in number, where the ith foam panel 214 is represented by 2141, and i=1, 2, . . . p. In the case where i≥2, p number of foam panels 214 are arranged in a side-by-side, contacting relationship (foam panel 214ₖ, foam panel 214ₖ₊₁, where 1<k≤p) to form a planar core layer 160 of arbitrary length, collectively presenting a planar first face and an opposing planar second face. The first face of core layer 160 is bonded to first surface layer 210 using for example a suitable adhesive, preferably a polyurethane based construction adhesive, and the second face of core layer 160 is bonded to second surface layer 215 using for example a suitable adhesive, preferably a polyurethane based construction adhesive. There is a seam 218 between adjacent foam panels 214. Foam panels 214 are made for example of expanded polystyrene (EPS) or polyurethane foam.

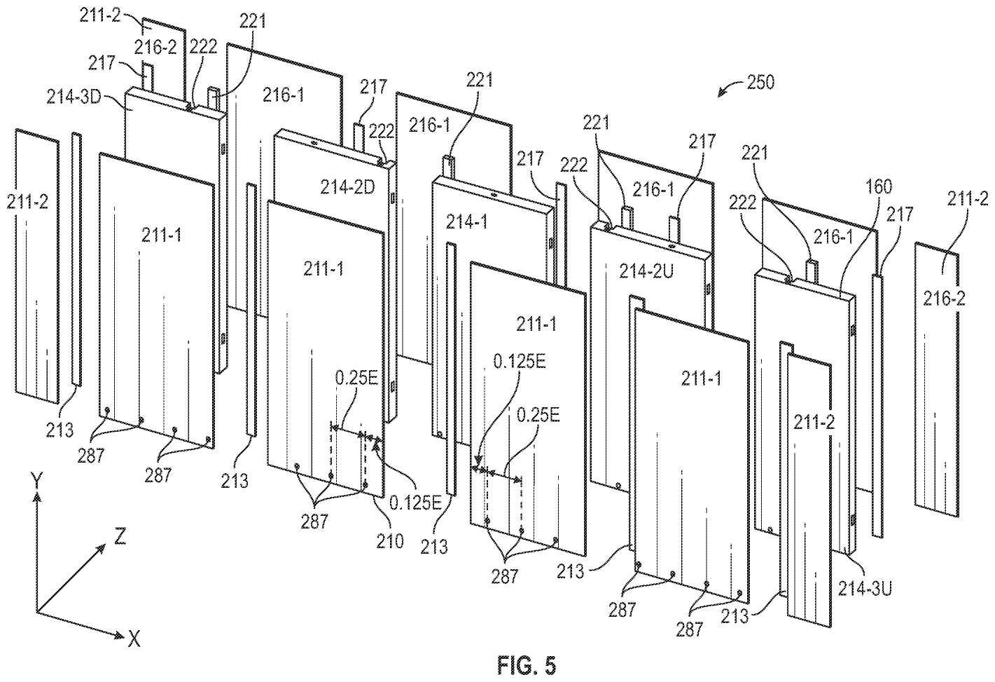

There are additionally provided a plurality of planar elongate reinforcement splines 221 spaced-apart across the length of core layer 160, as shown in FIGS. 4 and 5. Reinforcement splines 221 are received in recesses 222 cut into foam panels 214 to permit the second surface panels 216 to lie flat against core layer 160. Reinforcement splines 221 are made for example of lumber. In the embodiment shown, reinforcement splines 221 are provided on only one face of core layer 160, and preferably are disposed on the face that is distal from the interior of the structure 150. Optionally, reinforcement splines 221 can be provided in recesses 222 on both faces of core layer 160. Reinforcement splines 221 improve the bending resistance of the enclosure component 155.

As can be seen in the example of FIG. 4, the joinder splines 213 and 217 do not overlie the seams 218, but rather are offset a select distance so that the seams between and in each of the first surface layer 210 and second surface layer 215 do not match up with the seams 218 of core layer 216 across the thickness of enclosure component 155.

B. Enclosure Component Exterior Edge Reinforcement

The exterior edges of each enclosure component 155 (i.e., the edges that define the perimeter of enclosure component 155) can be provided with exterior edge reinforcement, as desired. Exterior edge reinforcement generally comprises an elongate, rigid member which can protect foam panel material that would otherwise be exposed at the exterior edges of enclosure components 155. Exterior edge reinforcement can be fabricated from one or more of laminated strand lumber board, wooden board, C-channel extruded aluminum or steel, or the like, and is generally secured to the exterior edges of enclosure component 155 with fasteners, such as screw or nail fasteners, and/or adhesive.

C. Enclosure Component Partitioning

Enclosure components 155 in certain instances are partitioned into enclosure component portions to facilitate forming a compact shipping module 15. In those instances where an enclosure component 155 is partitioned into enclosure component portions, any exterior edge reinforcement on the exterior edges defining the perimeter of the enclosure component is segmented as necessary between or among the portions.

The enclosure component portions can be joined by hinge structures or mechanisms to permit the enclosure component portions to be “folded” and thereby contribute to forming a compact shipping module 15.

D. Enclosure Component Interior Edge Reinforcement

An enclosure component 155 partitioned into enclosure component portions will have interior edges. There will be two adjacent interior edges for each adjacent pair of enclosure component portions. Such interior edges can be provided with interior edge reinforcement. Similar to exterior edge reinforcement, such interior edge reinforcement generally comprises an elongate, rigid member which can protect foam panel material that would otherwise be exposed at the interior edges of enclosure components 155. Interior edge reinforcement can be fabricated from one or more of laminated strand lumber board, wooden board, C-channel extruded aluminum or steel, or the like, and is generally secured to the interior edges of enclosure component 155 with fasteners, such as screw or nail fasteners, and/or adhesive.

E. Enclosure Component Sealing Systems

Structure 150 comprises a number of wall, floor and roof components with abutting or exposed exterior edges, as well as a number of partitioned wall, floor and roof components with adjacent interior edges. In this regard, sealing structures can be utilized, with the objective to limit or prevent the ingress of rain water, noise and outside air across these exterior and interior edges into the interior of structure 150.

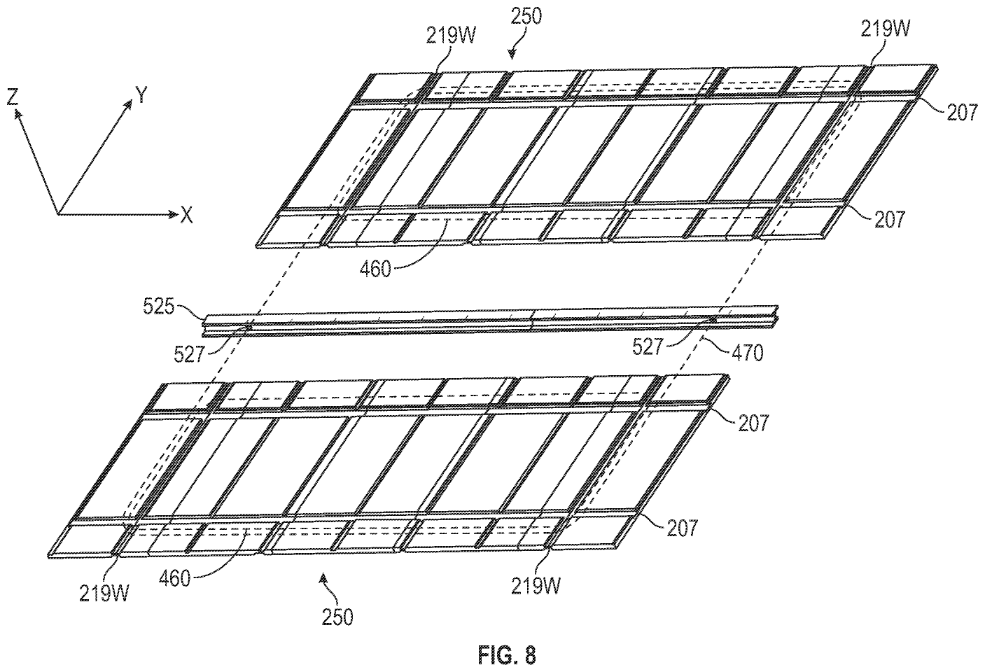

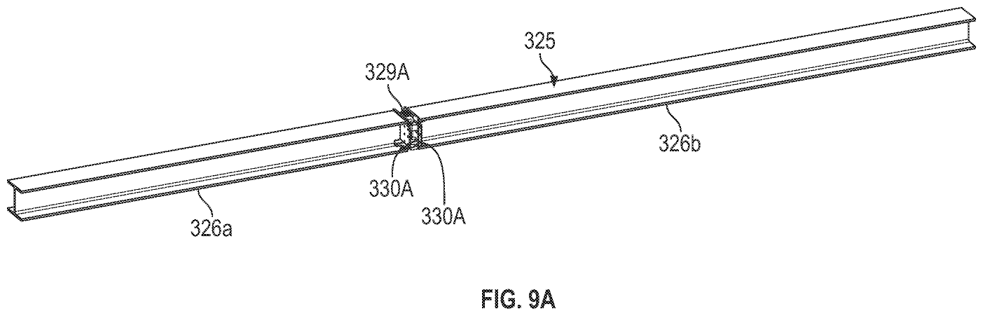

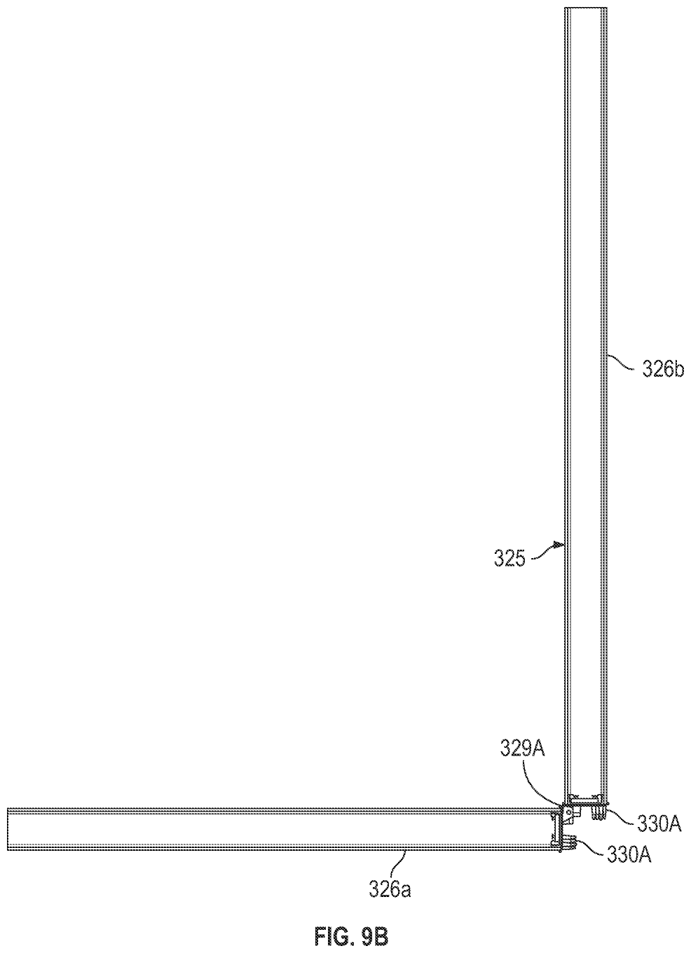

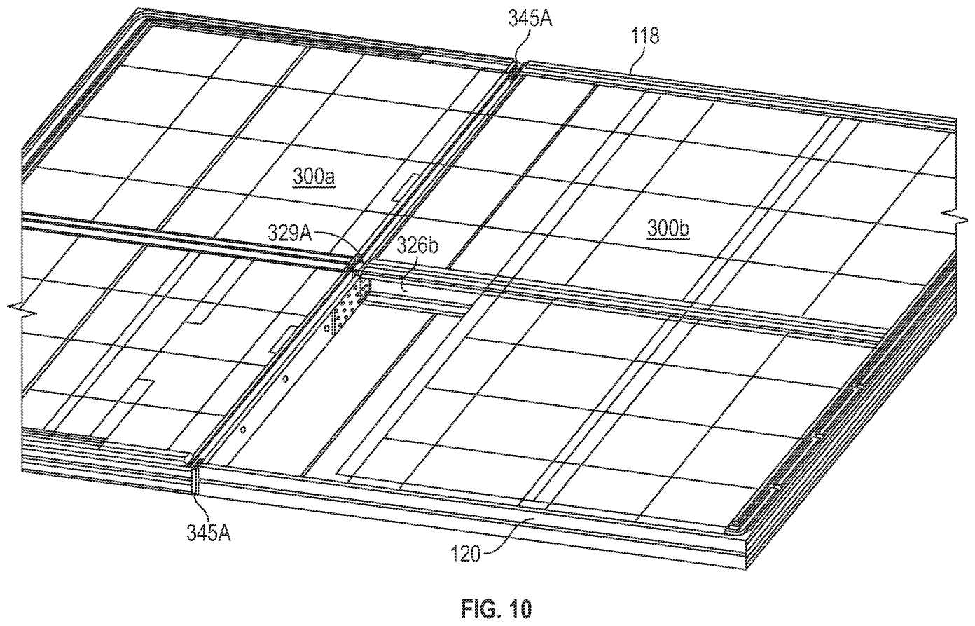

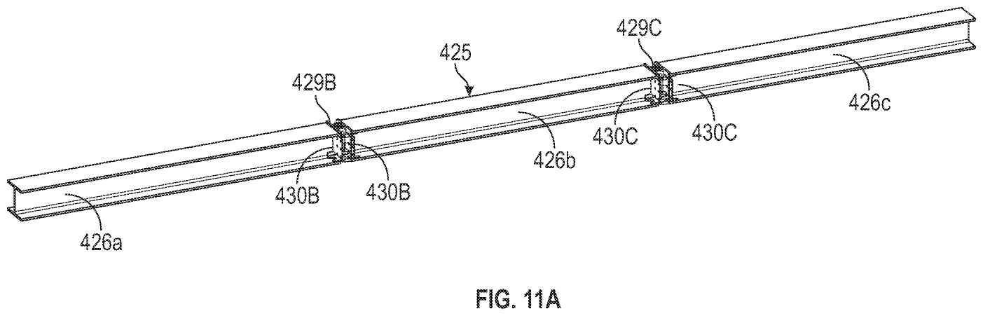

Particular sealing structures for accomplishing the foregoing objective are described in U.S. Non-Provisional patent application Ser. No. 17/504,883, filed on Oct. 19, 2021, entitled “Sheet/Panel Design for Enclosure Component Manufacture” and having the same inventors as the present application, and in PCT Patent Application No. PCT/US21/56415, entitled “Enclosure Component Sealing Systems,” filed on Oct. 25, 2021 and having the same inventors as the present application. The contents of that U.S. Non-Provisional patent application Ser. No. 17/504,883, filed on Oct. 19, 2021, entitled “Sheet/Panel Design for Enclosure Component Manufacture” and having the same inventors as the present application, are hereby incorporated by reference as if fully set forth herein, particularly including the sealing systems described for example at ¶¶0083-0170 and depicted in FIGS. 10-20 thereof, and also including the exemplary placements for such sealing systems described in ¶¶0171-0177 and depicted in FIGS. 21A-21B thereof. The contents of that PCT Patent Application No. PCT/US21/56415, entitled “Enclosure Component Sealing Systems,” filed on Oct. 25, 2021 and having the same inventors as the present application, are also incorporated by reference as if fully set forth herein, particularly including the sealing systems described for example at ¶¶0080-0167 and depicted in FIGS. 9-20 thereof, and also including the exemplary placements for such sealing systems described in ¶¶0168-0174 and depicted in FIGS. 8A-8B thereof.

F. Enclosure Component Load Transfer

In the case of enclosure components 155, it is necessary to transfer the loads imposed on their surfaces to their exterior edges, where those loads can be transferred either to or through adjoining walls, or to the building foundation. For enclosure components 155 that are horizontally oriented when in use (floor component 300 and roof component 400), such loads include the weight of equipment, furniture and people borne by their surfaces, as well as vertical seismic loads. For enclosure components that are vertically oriented when in use (wall component 200), such loads include those arising from meteorological conditions (hurricanes, tornadoes, etc.) and human action (vehicle and other object impacts).

For this purpose, multi-layered, laminate design shown in FIG. 4 will function to transfer the loads described above. To add additional load transfer capability, structural members, such as beams and/or joists, can be utilized within the perimeter of the enclosure components 155, as is deemed appropriate to the specific design of structure 150 and the particular enclosure component 155, to assist in the transfer of loads to the exterior edges. Particular embodiments of such structural members which can be used in floor components 300 and roof components 400, which also incorporate hinge structures, are described below.

G. Planar Component Manufacture

The enclosure components 155 (wall components 200, floor components 300 and roof components 400), as well as interior walls 125 (discussed below), can all be fabricated from a subassembly that is referred to herein as a component workpiece 250. The principal constituent elements of workpiece 250 for all enclosure components 155 can be the same, differing if at all only in certain dimensions. Likewise the principal constituent elements of the interior walls 125 can be the same as the enclosure components 155, differing only in certain dimensions and optionally omitting reinforcement splines 221 if interior walls 125 will not be load bearing. Enclosure components 155 and interior walls 125 are generically referred to herein as planar components 280 in this disclosure.

An embodiment of workpiece 250 for an enclosure component 155 is shown in exploded form in FIG. 5. In this embodiment, first and second surface layers 210, 215 can be cement board, joinder splines 213, 217 can be steel strip, and reinforcement spline 221 can be lumber.

The workpiece 250 in the FIG. 5 embodiment uses six planar rectangular first surface panels 211 for first surface layer 210. Four of these first surface panels 211 have the same width and length (X, Y direction respectively in FIG. 5), and are designated “211-1” in FIG. 5. In the embodiment shown, the remaining two of the six first surface panels 211, designated “211-2” in FIG. 5, each has the same length as first surface panels 211-1, but is smaller in width than first surface panels 211-1. Each first surface panel 211-2 of the workpiece 250 has the same length and width as the other first surface panel 211-2.

The workpiece 250 in the FIG. 5 embodiment also uses six planar rectangular second surface panels 216 for second surface layer 215. Four of these second surface panels 211 have the same length and width, and are designated “216-1” in FIG. 5. In the embodiment shown, the remaining two of the six second surface panels 216, designated “216-2” in FIG. 5, each has the same length as first surface panels 216-1, but is smaller in width than first surface panels 216-1. Each second surface panel 216-2 of the workpiece 250 has the same length and width as the other second surface panel 216-2.

In the embodiment shown in FIG. 5, each first surface panel 211 can be 114 inches (2.9 m) long (Y direction in FIG. 5), and that each second surface panel 216 also can be 114 inches (2.9 m) long. As indicated above, first surface panels 211 are provided in two widths (X direction in FIG. 5). Thus in the FIG. 5 embodiment, there can be a first width of 48 inches (1.22 m) for first surface panel 211-1, and a second width of 18 inches (0.46 m) for first surface panel 211-2. Likewise, second surface panels 216 also are provided in two widths. Thus in the FIG. 5 embodiment, there can be a first width of 48 inches (1.22 m) for second surface panel 216-1, and a second width of 18 inches (0.46 m) for second surface panel 216-2. First surface panels 211 and second surface panels 216 can be for example 0.3125 in (0.7938 cm) thick cement board.

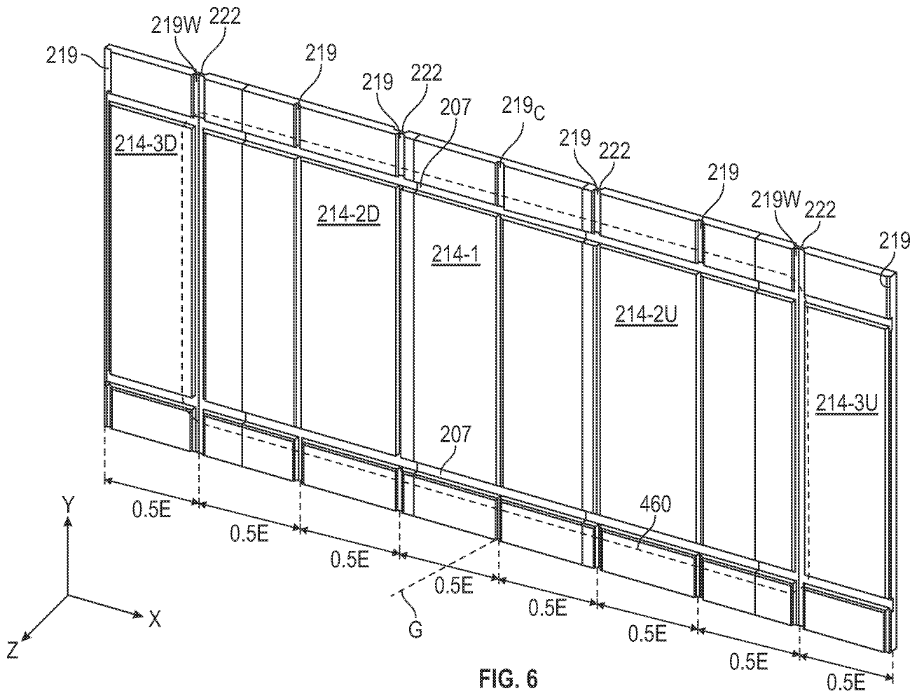

The workpiece 250 additionally uses five planar rectangular foam panels 214 for core layer 160, each having in the embodiment shown the same length (Y-direction in FIG. 5) as surface panels 211, 216; thus if surface panels 211, 216 are 114 inches (2.9 m) long, then foam panels are 114 inches (2.9 m) long. Each of the foam panels 214 is provided with one or more elongate vertically-oriented internal passageways extending parallel to the y-axis, referred to as vertical chases 219, spanning the distance between their top and bottom edges. Vertical chases 219 facilitate the installation of utility lines. The foam panels 214 in the depicted embodiment are also provided with one or more horizontal internal passageways, referred to as horizontal chases 207, which span the width of foam panels 214. The horizontal chases 207 extend parallel to the X-axis in FIG. 5, perpendicular to the Y-axis, and generally in the same plane as the vertical chases 219 such that and the horizontal chases 207 intersect vertical chases 219. Horizontal chases 207 facilitate wiring across enclosure component 155. The vertical chases 219 and horizontal chases 207 are formed in and completely surrounded by the foam of the foam panels along their lengths, except that the ends of the vertical chases 219 and horizontal chases 207 can be accessible at one or more edges of the work piece 250 and/or the vertical chases 219 and horizontal chases 207 can be accessed via any cutout formed in the workpiece 250. Reference to vertical, horizontal, top and bottom with respect to the workpiece 250 is provided to illustrate a relative relationship of the components that form the workpiece 250 as it is illustrated in FIGS. 5 and 6, not necessarily relative to the shipping module 15 or structure 1250. For example, as the workpieces 250 can be utilized to form a wall component 200, a floor component 300, and a roof component 400, the orientation of the workpieces will vary.

The placement of vertical chases 219 and horizontal chases 207 in foam panels 214 is shown in the cross-section of core layer 160 of FIG. 6 taken along the X-Y axis. The vertical chases 219 can be uniformly spaced apart a distance equal to 0.5 E, which in the embodiment shown is a distance of 28.5 inches (72.4 cm). Additionally, one of the vertical chases 219, denominated 219_{C} in FIG. 6, can be positioned at the X-direction mid-length point of core layer 160 (see FIG. 6), and that the remaining chases 219 be spaced outward 0.5 E to each side of that mid-length point vertical chase 219_{C}. There can be an even number of horizontal chases 207 symmetrically placed above and below the Y-direction mid-length point of core layer 160; in the embodiment shown in FIG. 6, there are two such horizontal chases 207 in core layer 160. In the case where foam panels 214 are 114 inches (2.9 m) long (Y direction in FIG. 5), then the first such horizontal chase 207 can be positioned 16 inches (40.6 cm) above the bottom edge of core layer 160 (Y direction in FIG. 6), and the second such horizontal chase 207 can be positioned 16 inches (40.6 cm) below the top edge of core layer 160. The horizontal chases 207 in each of the adjacent foam panels 214 are aligned to provide a path of communication across the length (X direction in FIG. 6) of the workpiece 250.

The vertical and horizontal passageways in foam panels 214 defining vertical and horizontal chases 219 and 207 can be formed prior to assembly of foam panels 214 into the laminate multi-layer structure of workpiece 250. These passages can be formed for example by use of a hot wire shaped and directed to form within panels 214 a cylindrical or other desired closed shape, thereby forming a foam plug severed from the bulk foam. Removal of the foam plug yields the desired passageway defining a vertical chase 219 or a horizontal chase 207.

Each chase 207, 219 preferably is provided with a diameter sufficient to permit the installation of utility lines. The vertical chase 219 in each foam panel 214-3, designated 219W in FIG. 6, can be made larger in cross-section than the vertical chases in other locations. In the embodiment shown in FIG. 6, the two horizontal chases 207 shown running through the foam panels 214 each has the same area in cross-section as vertical chases 219W. Thus each vertical chase 219W has an oval shape with a major diameter for example of approximately 5 inches (12.7 cm), and each horizontal chase 207 in foam panels 214-1, 214-2 and 214-3 has an oval shape with a major diameter of approximately 5 inches (12.7 cm). In comparison, each of the vertical chases 219 in foam panels 214-1 and 214-2 has a circular shape with a diameter of approximately 1.5 inches (3.8 cm). Notably, a loop pathway, utility service sub-system 460, can be traced through vertical chases 219W and horizontal chases 207 in the foam panels 214 (shown as a dashed line in FIG. 6), which sub-system is generally located about the periphery of work piece 250, and through which utility trunk lines can be conveniently routed and connected to service lines.

On one of the faces of the foam panels 214 for core layer 160, there are provided at select intervals the recesses 222 that will receive reinforcement splines 221. The recesses 222 can be uniformly spaced apart a distance equal to E, which in the embodiment shown is a distance of 57 inches (145 cm). In addition, the recesses 222 (and the reinforcement splines 221 therein) can be symmetrically positioned to each side of the X-direction mid-point of core layer 160.

The X-direction mid-point of one of these foam panels 214, designated “214-1” in FIG. 5, is positioned to coincide with the X direction mid-point (in FIG. 5) of the workpiece 250. The width of foam panel 214-1 in the FIG. 5 embodiment is 48 inches (1.22 m). Further, when workpiece 250 is utilized in accordance with the manufacturing sequences described below, and if the workpiece 250 is used to fabricate:
(a) a wall component 200, then foam panel 214-1 will be located at the mid-point of the wall component 200; or
(b) a floor component 300, then foam panel 214-1 will be located at the mid-point of the floor component (in the transverse direction); or
(c) a roof component 400, then foam panel 214-1 will be located at the mid-point of the roof component (in the transverse direction).

Further, foam panel 214-1 in the embodiment shown is symmetric about its “X” and “Y” axes; i.e., the vertical chase 219 and horizontal chases 207 in foam panel 214-1 are symmetrically located within foam panel 214-1 about the X, Y axes bisecting foam panel 214-1.

In the embodiment shown, workpiece 250 includes only one foam panel 214-1. In the embodiment shown in FIG. 5, there is but one vertical chase 219, chase 219_{C} as previously noted, located at the Y axis bisecting foam panel 214-1. As may be appreciated from the foregoing, and as illustrated in FIG. 6, vertical chase 219_{C} will coincide with one of the mid-point grid lines G, the particular one (G_{L} or G_{T}) depending upon the enclosure component 155 in which the workpiece 250 is used.

The foam panels 214 placed to each side of foam panel 214-1 and in contact with foam panel 214-1 are designated as foam panels 214-2 in FIG. 5. In the embodiment shown, each foam panel 214-2 is symmetric about its X axis, but not about its Y axis; i.e., the horizontal chases 207 in foam panel 214-2 are symmetrically located about the X axis bisecting foam panel 214-2 (and align with the horizontal chases 207 in foam panel 214-1), but the vertical chases 219 are not symmetrically located about the Y axis bisecting foam panel 214-2.

In the embodiment shown in FIG. 5, the width of foam panel 214-2 is 48 inches (1.22 m). There is a first vertical chase 219 located in foam panel 214-2, spaced 0.5 E from vertical chase 219_{C}, which in the embodiment depicted is 4.5 inches (11.43 cm) from the edge of foam panel 214-2 abutting foam panel 214-1. In addition, there is a second vertical chase 219 located in foam panel 214-2, spaced E from vertical chase 219_{C}, which in the embodiment depicted is thirty three inches (83.8 cm) from the edge of foam panel 214-2 abutting foam panel 214-1. Furthermore, on one face of foam panel 214-2, there is provided a recess 222, which after assembly of work piece 250 is located a distance E from the X-direction mid-point of foam panel 214-1, which location in the embodiment depicted is 4.5 inches (11.43 cm) from the edge of foam panel 214-2 abutting foam panel 214-1. This recess 222 when so positioned will overlie the vertical chase 219 located in foam panel 214-2 which is spaced 0.5 E from vertical chase 219_{C}, as can be seen in FIG. 6.

In assembly, one of the foam panels 214-2 is rotated 180 degrees (180°) about its Z axis relative to the other of the foam panels 214-2, to result in the vertical chases 219 in foam panels 214-2 to be symmetrically located about the Y axis bisecting foam panel 214-1. For this reason, one of the foam panels 214-2 in FIG. 5 is designated 214-2U, and the other is designated 214-2D, to reflect their different orientations.

The foam panels placed to each side of foam panels 214-2 in FIG. 5 are designated foam panels 214-3. In the embodiment shown, each foam panel 214-3 is symmetric about its X axis, but not about its Y axis; i.e., the horizontal chases 207 in foam panel 214-3 are symmetrically located about the X axis bisecting foam panel 214-3 (and align with the horizontal chases 207 in foam panel 214-2), but the vertical chases 219 are not symmetrically located about the Y axis bisecting foam panel 214-3.

In the embodiment shown in FIG. 5, the width of foam panel 214-3 is 42 inches (1.07 m). There is a first vertical chase 219 located in foam panel 214-3, spaced 1.5 E from vertical chase 219_{C}, which in the embodiment depicted is 13.5 inches (34.3 cm) from the edge of foam panel 214-3 abutting foam panel 214-2. In addition, there is a second vertical chase 219 located in foam panel 214-3, spaced 2 E from vertical chase 219_{C}, which in the embodiment depicted is at the exterior edge of foam panel 214-3; i.e., 42 inches (106.7 cm) from the edge of foam panel 214-2 abutting foam panel 214-3. Furthermore, on one face of foam panel 214-3, there is provided a recess 222, which after assembly of work piece 250 is located a distance 1.5 E from the Y direction mid-point of foam panel 214-1, which location in the embodiment depicted is 13.5 inches (34.3 cm) from the edge of foam panel 214-3 abutting foam panel 214-2. This recess 222 when so positioned will overlie the vertical chase 219 located in foam panel 214-3 which is also spaced 1.5 E from vertical chase 219c.

In assembly, one of the foam panels 214-3 is rotated 180 degrees (180°) about its Z axis (see FIG. 5) relative to the other of the foam panels 214-3, to result in the vertical chases 219 in foam panels 214-3 to be symmetrically located about the Y axis bisecting foam panel 214-1. For this reason, one of the foam panels 214-3 in FIG. 5 is designated 214-3U, and the other is designated 214-3D, to reflect their different orientations. If first surface panels 211 and second surface panels 216 are 0.3125 in (0.7938 cm) thick, and if the foam panels 214 are made 5.375 in (13.65 cm) thick, then workpiece 250 will have an overall thickness of 6 in (15.24 cm).

FIG. 5 depicts a number of spaced-apart toe screw apertures 287 in each of the four first surface panels 211-1. In the event that workpiece 250 is to be used to manufacture wall component 200, these apertures 287 can be provided to receive toe screw housings which facilitate fastening the wall component 200 to a floor component 300. In use, a toe screw housing is inserted into a toe screw aperture 287, following which a fastener, such as a SIP screw, can be inserted and driven into the underlying exterior edge reinforcement of both the wall component 200 and the underlying floor component 300, to fasten the wall component 200 to the floor component 300. A detailed description of the construction of one embodiment of a toe screw housing is set forth in U.S. Non-Provisional patent application Ser. No. 17/587,051 entitled “Wall Component Appurtenances”, filed Jan. 28, 2022 and having the same inventors as the subject application. The contents of that U.S. Non-Provisional patent application Ser. No. 17/587,051 entitled “Wall Component Appurtenances”, filed Jan. 28, 2022 and having the same inventors as the subject application, is incorporated by reference as if fully set forth herein, particularly the description of the construction of toe screw housing 288, set forth for example in ¶¶0048-0055 and in FIGS. 8A-8C thereof. Toe screw apertures 287 need not be provided in work pieces 250 intended for use in floor components 300 or roof components 400.

It is desirable for toe screw apertures 287 not to overlie any of the vertical chases 219, so as to avoid a fastener being driven through for example electrical wiring running through chases 219. In this regard, when the dimensional relationships and dimensions for workpiece 250 described above are employed, the seam between the inner two first surface panels 211-1 will overlie the chase 219_{C} in foam panel 214-1. Thus, by placing the first aperture 287 to each side of this seam a distance equal to 0.125 E, or 7.125 inches (18.1 cm), and spacing apart each succeeding aperture 287 a distance equal to 0.25 E, or 14.25 inches (36.2 cm), the toe screw apertures 287 will not overlie any of the vertical chases 219. This spacing pattern for toe screw apertures 287 is shown in FIG. 5. Optionally, where the manufacture of a workpiece 250 is intended for a wall component 200, the cutting of apertures 287 can be performed on individual panels 211 prior to assembling first surface layer 210.

In the embodiment of FIG. 5, joinder splines 213, 217 can be steel strip 112 to 114 inches (2.84 to 2.90 m) in length (Y axis in FIG. 5), four inches (10.16 cm) in width (X axis in FIG. 5) and 0.024 inch (0.061 mm) thick (Z axis in FIG. 5). In turn, reinforcement splines 221 can be lumber 112 to 114 inches (2.84 to 2.90 m) in length (Y axis in FIG. 5), 3.5 inches (8.89 cm) in width (X axis in FIG. 5) and 1.5 inches (3.81 cm) thick (Z axis in FIG. 5).

As shown in FIG. 8, certain enclosure components 155, such as the floor component 300 and ceiling component 400, can include two identical workpieces 250 joined together along their length by an enclosure component beam assembly 525 (e.g., which can be embodied as floor beam assembly 325 or roof beam assembly 425 described herein) such that the enclosure component beam assembly 525 is positioned between the two workpieces 250. As described herein, the workpiece 250 can each include the vertical chases 219 and horizontal chases 207, where vertical chases 219W and the horizontal chases 207 can define the utility service sub-systems 460, one in each of the workpieces 250. Additionally, when the workpieces 250 are joined by the enclosure component beam assembly 525, the workpieces 250 are aligned so that the vertical chases 219W of each workpiece are aligned with each other. The beam assembly can include openings that also align with the vertical chases 219W such that the aligned vertical chases 219W on opposite sides of the beam assembly can be in communication with each other. In this configuration, the vertical chases 219W and the horizontal chases 207 that are proximate to a periphery of the enclosure component can form a closed path or loop, utility service system 470 that extends through the two workpieces 250 and the beam assembly 525. As further described herein the enclosure component beam assembly 525 can be formed of multiple beams joined together by one or more hinges (e.g., beam assemblies 326 and 426) and the workpieces 250 can be cut along hinge lines to allow the enclosure components to move between a folded position and an unfolded position. As may be understood, utility service system 470 is generally located about the periphery of the enclosure component 155 and comprises major portions of the vertical chases 219W and major portions of the horizontal chases 207 proximate the edges of the enclosure component 155. Utility service system 470 is a pathway through which utility trunk lines can be conveniently routed and connected to service lines, and also provides communication between the two utility service sub-systems 460 in the work pieces 250.

### Planar Component Assembly Facility

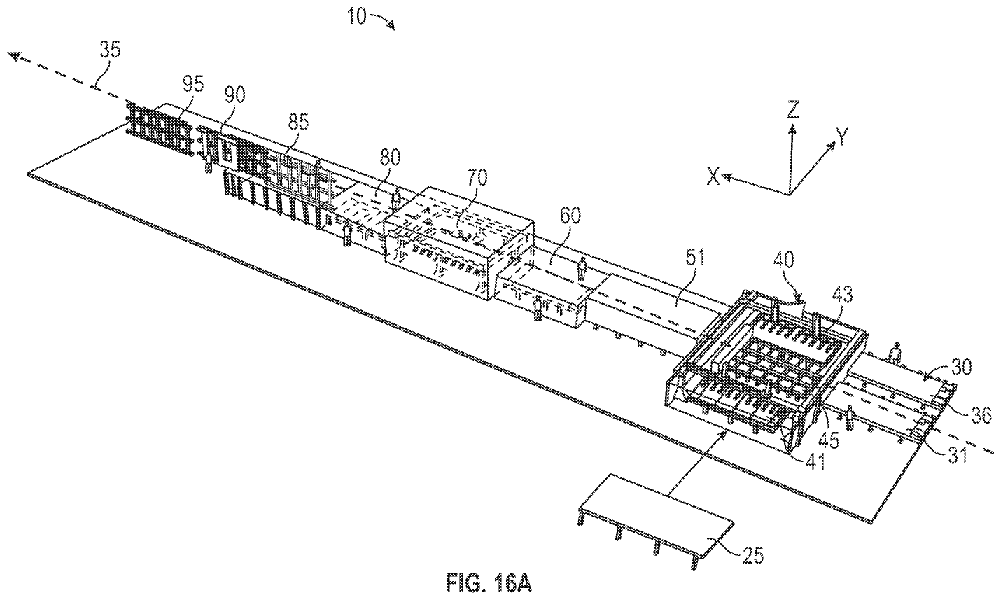

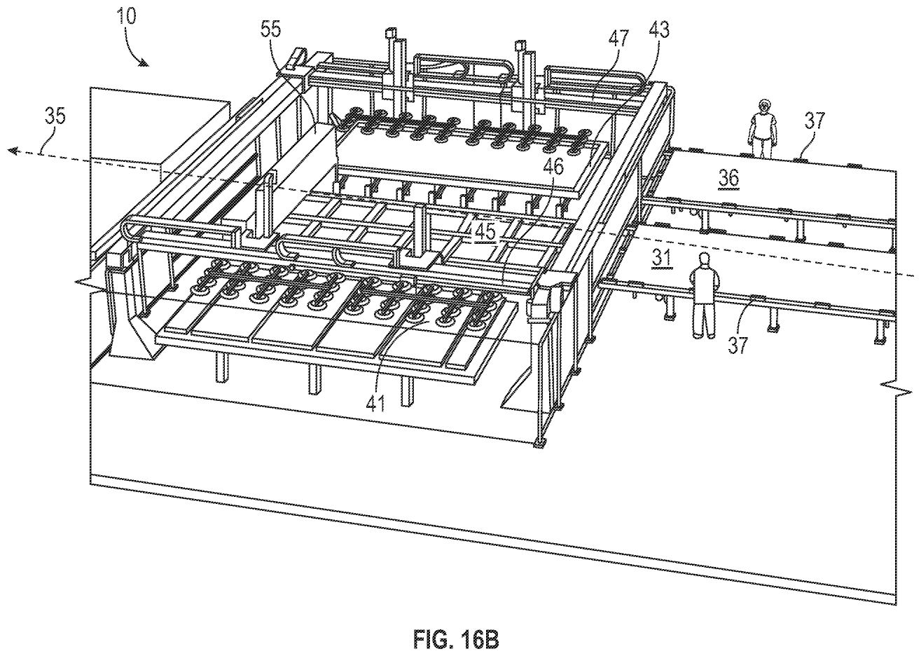

It is preferred that the principal assembly preparation sequences for manufacturing all planar components 280, both the enclosure components 155 and the interior walls 125, be performed using the facility 10 shown in FIG. 16A. Facility 10 comprises the following manufacturing regions: surface panel load station 30, a build-up cell 40, a press 51, an inspection station 60, a CNC cell 70, and work cells 80, 85, 90 and 95. These manufacturing regions are generally arranged linearly, one after the other as shown in FIG. 16A. As the manufacturing preparation sequences proceed, the product flow traces a generally linear flow path 35 from right to left in the X direction shown in FIG. 16A, with components and sub-assemblies being added at load station 30 and build-up cell 40.

Load station 30 in the embodiment shown in FIG. 16A includes two load tables, first load table 36 and second load table 31. As depicted in FIG. 16A, the second load table 31 is positioned laterally displaced in the Y direction in front of the first load table 36 (closer to the viewer). First load table 36 is for receiving the first surface panels 211 of first surface layer 210, and second load table 31 is for receiving the second surface panels 216 of second surface layer 215. Aligning rails 37 can be provided about the periphery of each of first load table 36 and second load table 31 to approximately square up the panels 211, 216 placed on the load tables. The aligning rails 37 project upwardly in the z-direction from the periphery of the first load table 36 and the second load table 31. Tables 31, 36 are provided with rollers allowing the surface panels placed thereon to be moved in the X direction into build-up cell 40.

Referring to FIG. 16B, the build-up cell 40 includes a planar rectangular foam assembly ready table 41. As shown in FIG. 16B, foam assembly ready table 41 is positioned laterally displaced in the Y direction in front of the flow path 35, and is for receiving a foam layer assembly from assembly table 25 (both described below).

The build-up cell 40 additionally includes a planar rectangular surface assembly ready table 43 shown in FIG. 16B. Surface assembly ready table 43 has staging table edge fixtures 44 (not shown) placed around its rectangular periphery. These edge fixtures 44 can be for example planar rectangular plates that are moveable between an open position and a closed position in which their surfaces are oriented perpendicular to the plane of ready table 41 so as to form a rectangular squaring frame. Surface assembly ready table 43 is positioned laterally displaced in the Y direction behind flow path 35 in opposition to foam assembly ready table 41.

The build-up cell 40 further includes a generally rectangular assembly bed 45 which as shown in FIG. 16B is located between foam assembly ready table 41 and surface assembly ready table 43, within flow path 35. Like staging table 43, assembly bed 45 has staging table edge fixtures 44 (not shown) placed around its rectangular periphery. These edge fixtures 44 can be for example planar rectangular plates that are moveable between an open position and a closed position in which their surfaces are oriented perpendicular to the plane of assembly bed 45 so as to form a rectangular squaring frame.

An adhesive gantry 55 straddles the conveyor table 50 and is linearly movable in the X direction from a first position distal from load station 30 to a second position proximate to load station 30. Adhesive gantry 55 is provided with a number of downward-directed nozzles, each of which deposits an extrusion of adhesive, such as a water activated polyurethane construction adhesive, onto such items as may be placed upon assembly bed 45, as directed. Adhesive gantry 55 is additionally provided with a number of water misters that spray a fine mist that activates the extruded adhesive. It is preferred that adhesive gantry 55 be capable of providing an adhesive coverage of 20 g/ft²+/−2.5 g/ft² and water coverage of 2.0 g/ft²+/−0.2 g/ft².

The build-up cell 40 additionally includes first lifter 46 and second lifter 47, each of which is linearly movable in the Y direction and in the Z direction shown in FIG. 16B. First lifter 46 is linearly moveable in the Y direction between the foam assembly ready table 41 and the assembly bed 45, and is linearly moveable in the Z direction to engage a planar item positioned on foam assembly ready table 41 and lift it above the table 41 and above the X direction line of travel of the uppermost portions of adhesive gantry 55. Second lifter 47 is linearly moveable in the Y direction between the surface assembly ready table 43 and the assembly bed 45, and is linearly moveable in the Z direction to engage a planar item positioned on surface assembly ready table 43 and lift it above the table 43 and above the X direction line of travel of the uppermost portions of adhesive gantry 55. Lifters 46 and 47 can each be a vacuum lifter, a mechanical lifter or a combined vacuum and mechanical lifter.

As indicated above, the facility 10 includes an assembly table 25, which is a rectangular table with its longer edges oriented in the X direction shown in FIG. 16A. Foam layer assemblies (described below) are prepared on assembly table 25 for delivery to foam assembly ready table 41. Assembly table 25 is not in the path of flow path 35. Table 25 has an automated nailing system that includes a number of horizontally oriented nail guns disposed along the X direction edges for securing certain components to the foam layer sub-assemblies, as described below.

Downstream of the build-up cell 40, the facility 10 further includes a press table 51 in the path of flow path 35. Press table 51 can be for example a hydraulically or pneumatically actuated press table. Press table 51 is for pressing together the superposed foam and surface panels received from build-up cell 40.

Downstream of the press table 51, the facility 10 further includes an inspection station 60 in the flow path of flow path 35. Laminates delivered from press table 51 can be inspected here, and if found to be unacceptable, can be removed from the process stream.

Downstream of inspection station 60, the facility 10 further includes a CNC cell 70 in the path of flow path 35. CNC cell 70 can contain for example a processor controlled saw, laser or waterjet cutter capable of making at least vertical cuts. A saw cutter is preferred for accuracy in the case of the manufacture of enclosure components 155 that include reinforcement splines 221. CNC cell 70 is for cutting door apertures 202 and window apertures 204 in workpieces 250 intended for wall components 200, as well as for separating into wall component portions those workpieces 250 intended for partitioned wall components 200s.

Downstream of CNC cell 70, the facility 10 further includes work station 80, at which any further operations to further prepare workpieces 250 can be performed. Work station 80 further permits accommodation of variations in the process flow through facility 10, which can arise for example from variations in the time required to perform cutting operations conducted in CNC cell 70. Inspection station 60, located upstream of CNC cell 70, can be used to perform a like function.

Downstream of work station 80, the facility 10 further includes tilt station 85, at which workpieces 250 are rotated from a horizontal to a vertical orientation in a suitable jig, and work station 90, which is downstream of tilt station 85. Certain other manufacturing operations can be performed at both tilt station 85 and work station 90, as further described below.

Downstream of work station 90, the facility 10 further includes work station 95, at which workpieces 250 are raised and linked to a conveyor to move the workpieces to locations at which painting and other finishing steps can be performed.

The process flow for manufacturing workpiece 250 can proceed in various ways. An exemplary manufacturing process is provided below; and for ease of understanding, the manufacturing process is divided into the following six assembly preparation sequences:
1. Foam Layer Assembly Preparation;
2. First Surface Panel Assembly Preparation;
3. Second Surface Panel Assembly Preparation;
4. Lamination Component Marshalling;
5. Lamination Component Build-Up; and
6. Lamination Press.

Although divided into these separate assembly preparation sequences for ease of understanding, as indicated below some assembly sequences and their steps are dependent on the completion of prior assembly sequences and steps, and some sequences and steps may overlap in time with other assembly sequences and steps.

It is assumed in this exemplary manufacturing process flow that a workpiece 250 is being fabricated for an enclosure component 155. However, it should be understood that the same sequence can be utilized to prepare an interior wall 125.

1. Foam Layer Assembly Preparation

In the assembly preparation sequences described herein, from time to time there is reference to a “foam layer assembly.” The foam layer assembly comprises the exterior edge reinforcement, the foam panels 214, the joinder splines 213 and 217, and the reinforcement splines 221 positioned in the recesses 222 of foam panels 214, all being appropriately positioned and bonded together to form a unitary structure.

One sequence of steps to form a foam layer assembly, in which the joinder splines 213, 217 and the reinforcement splines 221 are bonded to the foam panels 214 prior to the panels 214 being positioned together, is described below:
(a) Using foam panel 214-3 as an example of how this preparation step (a) can be performed, the panel 214-3 is positioned so that its recess 222 is face up, following which a suitable adhesive, such as a polyurethane based construction adhesive, is applied in the recess 222 and a reinforcement spline 221 is positioned in the recess 222. Likewise, a suitable adhesive, such as a polyurethane based construction adhesive, is applied to the location at which a joinder spline 217 is to be located, following which a joinder spline 217 is placed at that location.
(b) The panel 214-3 is then turned over and a suitable adhesive, such as a polyurethane based construction adhesive, is applied to the location at which a joinder spline 213 is to be located, following which a joinder spline 213 is placed at that location.
(c) The foregoing preparation steps (a) and (b) can also be carried out on the two foam panels 214-2 and the two foam panels 214-1 (except in the latter case no reinforcement spline 221 is used). Locating features can be provided in the foam panel 214-1, 214-2 and 214-3 to assist manufacturing personnel in placing the joinder splines 213, 217 at their proper locations.
(d) Core layer 160 is then formed by arranging foam panels 214 side-by-side on table 25, in the manner shown and described in reference to FIGS. 4 and 5 and prepared in accordance with steps (a)-(c), with the reinforcement splines 221 face down.
(e) Segments of the exterior edge reinforcement to be secured about the periphery of core layer 160 are next brought into suitable locations proximate to assembly table 25. A suitable adhesive, such as a polyurethane based construction adhesive, is applied to a face of the segments and/or to the periphery of the core layer 160, as desired, and the exterior edge reinforcement segments are pressed against the periphery of the foam of core layer 160.
(f) The automated nailing system of assembly table 25 then nails the assembly. It is preferred that nails be driven at positions that fasten together the four segments of the exterior edge reinforcement in the manner of a picture frame, and that nails also be driven to secure the reinforcement splines 221 to the abutting exterior edge reinforcement segments, thereby creating a very rigid wooden frame in and around the foam.
(g) The completed foam layer assembly is then moved to the “foam assembly ready position” on foam assembly ready table 41.

As may be understood, step (g) frees up foam assembly table 25 for the manufacture of a subsequent foam layer assembly, and steps (a) and (g) can then be repeated one or more times, as desired, subject to the availability of foam assembly ready table 41 of build-up cell 40. Notably, the foregoing steps (a), (b) and (c) can be performed in facility 10, such as on table 25, or elsewhere. Alternatively, steps (a), (b) and (c) can be performed in a separate facility, and the foam panel and spline assemblies can be inventoried and drawn from for placement on assembly table 25 as may be desired, for reasons such as to make the process flow more efficient.

2. First Surface Panel Assembly Preparation

An assembly preparation sequence to prepare a first surface panel assembly (defined presently) is described below:
(a) The first surface panels 211 are arranged side-by-side on first load table 36 in the following positional relationships, as shown in FIG. 5: 211-2/211-1/211-1/211-1/211-2. This forms a “first surface panel assembly”.
(b) (i) The first surface panel assembly is moved from first load table 36 to the “surface assembly ready position” on surface assembly ready table 43 of build-up cell 40, and then (ii) the edge fixtures 44 associated therewith (not shown) are actuated to perform a final squaring of the first surface panel assembly.

As may be understood, step (b)(i) frees up first load table 36 for the manufacture of a subsequent first surface panel assembly, and steps (a) and (b) can then be repeated one or more times, as desired, subject to the availability of surface assembly ready table 43 of build-up cell 40.

3. Second Surface Panel Assembly Preparation

An assembly preparation sequence to prepare a second surface panel assembly is described below:
(a) The second surface panels 216 are arranged side-by-side on second load table 31 in the following positional relationships, as shown in FIG. 5: 216-2/216-1/216-1/216-1/216-2. This forms a “second surface panel assembly”.
(b) (i) The second surface panel assembly is moved from second load table 31 to the “lamination build-up position” on assembly bed 45 of build-up cell 40, and then (ii) the edge fixtures 44 associated therewith are actuated to perform a final squaring of the second surface panel assembly.

As may be understood, step (b)(i) frees up second load table 31 for the manufacture of a subsequent second surface panel assembly, and steps (a) and (b) can then be repeated one or more times, as desired, subject to the availability of assembly bed 45 of build-up cell 40.

4. Lamination Component Marshalling

In the assembly preparation sequences described herein, from time to time there is reference to the “pounce” position. The pounce position is a position above assembly bed 45 and above the floor of facility 10 a distance in the Z direction greater than the uppermost portion of adhesive gantry 55. The pounce position is alternately occupied by either second lifter 47, bearing a first surface panel assembly, or first lifter 46, bearing a foam layer assembly.

A sequence of steps for marshalling the assemblies to be laminated is described below:

(a) First Lifter 46 Movement.

Movement 1. The first lifter 46 engages and lifts the foam layer assembly vertically from the foam assembly ready position to the “foam assembly standby position.” The foam assembly standby position is a position above table 41 and above the floor of facility 10 a distance in the Z direction greater than the uppermost portion of adhesive gantry 55. Preferably, the distance in the Z direction of the foam assembly standby position above the floor of facility 10 is equal to the distance in the Z direction of the pounce position above the floor of facility 10, or nearly so.

Movement 2. If the pounce position is not available (i.e., occupied by second lifter 47 bearing a first surface panel assembly), first lifter 46 remains at the foam assembly standby position. If the pounce position is or becomes available, first lifter moves the foam layer assembly from the foam assembly standby position to the pounce position.

Movement 3. Once the assembly bed 45 is accessible from the pounce position, and if a second surface panel assembly has been moved to the lamination build-up position and thereby presents an exposed face, the first lifter 46 moves from the pounce position to the lamination build-up position, to place the foam layer assembly borne by first lifter 46 onto the exposed face of the second surface panel assembly.

Movement 4. First lifter 46 moves from the lamination build-up position to the foam assembly standby position.

If there is not a subsequent foam layer assembly at the foam assembly ready position on foam assembly ready table 41, then first lifter 46 remains at the foam assembly standby position. If there is a subsequent foam layer assembly at the foam assembly ready position on foam assembly ready table 41, then Movements 1 through 4 can be repeated one or more times, as desired.

(b) Second Lifter 47 Movement.

Movement 1. After final squaring of the first surface panel assembly positioned upon surface assembly table 43 by edge fixtures 44 thereon, the second lifter 47 engages the first surface panel assembly and lifts it vertically from the surface assembly ready position to the “surface assembly standby position.” The surface assembly standby position is above table 43 and above the floor of facility 10 a distance in the Z direction greater than the uppermost portion of adhesive gantry 55. Preferably, the distance in the Z direction of the surface assembly standby position above the floor of facility 10 is equal to the distance in the Z direction of the pounce position above the floor of facility 10, or nearly so.

Movement 2. If the pounce position is not available (i.e., occupied by first lifter 46 bearing a foam layer assembly), second lifter 47 remains at the surface assembly standby position. If the pounce position is or becomes available, second lifter 47 moves the surface panel assembly from the surface assembly standby position to the pounce position.

Movement 3. Once the assembly bed is accessible from the pounce position, and if a foam layer assembly has been moved to the lamination build-up position and thereby presents an exposed face, the second lifter 47 moves from the pounce position to the lamination build-up position, to place the first surface panel assembly borne by second lifter 47 onto the exposed face of the foam layer assembly.

Movement 4. Second lifter 47 moves from the lamination build-up position to the surface assembly standby position.

If there is not a subsequent surface layer assembly at the surface assembly ready position on surface assembly table 43, then second lifter 47 remains at the foam assembly standby position. If there is a subsequent surface layer assembly at the surface assembly ready position on surface assembly table 43, then Movements 1 through 4 can be repeated one or more times, as desired.

5. Lamination Component Build-Up

The lamination component build-up sequence described below proceeds on the basis that a second surface panel assembly is in the lamination build-up position on assembly bed 45 of build-up cell 40, a foam layer assembly is in the pounce position by the end of step (a) below, and a surface panel assembly is in the pounce position by the end of step (c) below:
(a) Following the final squaring of the second surface panel assembly by the assembly edge fixtures 44 associated with assembly bed 45, the exposed face of the second surface panel assembly is coated with activated adhesive. This is accomplished by displacing adhesive gantry 55 over the second surface panel assembly between its first position and its second position while extruding adhesive, activated by a water mist, onto the exposed face.
(b) After completion of the foregoing step (a) and after the adhesive gantry 55 has cleared the region above the lamination build-up position, first lifter 46 moves the foam layer assembly from the pounce position to the lamination build-up position and places it on the exposed face of the second surface panel assembly.
(c) After the foam layer assembly is placed on the exposed face in the foregoing step (b), the exposed face of the foam layer assembly is coated with an activated adhesive. This is accomplished by displacing adhesive gantry 55 over the foam layer assembly between its first position and its second position while extruding adhesive, activated by a water mist, onto the exposed face.
(d) After completion of the foregoing step (c) and after the adhesive gantry 55 has cleared the region above the lamination build-up position, second lifter 47 moves the first surface panel assembly from the pounce position to the lamination build-up position and places it on the exposed face of the face of the foam layer assembly.
(e) Promptly after adhesive gantry 55 clears the region over assembly bed 45, second lifter 47 moves the first surface panel assembly, places it on the exposed face of the foam layer assembly, and thereby completing the superposed lamination assembly.

The lamination component assembly process can then be repeated, starting at step (a), as often as desired, upon moving a subsequent second surface panel assembly from second load table 31 to assembly bed 45.

Preferably, the movements of the first lifter 46 to the pounce position (Movement 2 of First Lifter 46 Movement, described above) and the second lifter 47 to the pounce position (Movement 2 of Second Lifter 47 Movement, described above) are accomplished in each instance prior to completing the displacement of adhesive gantry 55 between its first position and the second position.

6. Lamination Press
(a) Each superposed lamination assembly on assembly bed 45 is moved along flow path 35 from assembly bed 45 and are received in press 51, which applies pressure to securely bond the superposed assembly together. This completes the press-together assembly.

The pressed-together assembly is next moved along flow path 35 to inspection station 60, where it is checked for being within specified manufacturing tolerances. The result of the foregoing manufacturing operations is to produce a workpiece 250. That workpiece 250 is then subject to further manufacturing, as described in the sections immediately below, to produce a wall component 200, floor component 300, and roof component 400, as desired.

In one example embodiment, the operation and various movements of some, all, or none of the machines in the facility 10 can be controlled be one or more assembly control systems that includes at least one processor configured to execute code stored in memory to assembly the workpieces 250. As an example, an operation of the first lifter 46 and the second lifter 47 can be controlled by the one or more assembly control systems that includes the at least one processor configured to execute code stored in memory to, for example, control the coordinated movement of the first lifter 46 and the second lifter 47 to engage the foam layer assembly and the surface panel assembly, respectively, and to between the various positioned described herein for the first lifter 46 and the second lifter 47. As another example, an operation of the adhesive gantry 55 can be controlled by the one or more assembly control systems that includes the at least one processor configured to execute code stored in memory to, for example, control the movement of the adhesive gantry, the water misters, and the nozzles. As yet another example, an operation of the press table 51 can be controlled by the one or more assembly control systems that include the at least one processor configured to execute code stored in memory to, for example, actuate the hydraulics or pneumatics of the press table 51. As yet another example, an operation of the CNC cell 70 can be controlled by the one or more assembly control systems that include the at least one processor configured to execute code stored in memory to, for example, actuate and control the saw, laser or waterjet cutter to make vertical cuts in the workpiece 250. In other embodiments, the machines in the facility 10 can be operated by one or more operators and/or the machines in the facility can be operated by a combination of control systems and one or more operators.

### Wall Component (200)

Typically, structure 150 will utilize four wall components 200, with each wall component 200 corresponding to an entire wall of structure 150.

### A. General Description

Wall component 200 has a generally rectangular perimeter. As shown in FIG. 1B, wall components 200 have plural apertures, specifically a door aperture 202, which has a door frame and door assembly, and plural window apertures 204, each of which has a window frame and a window assembly. The height and length of wall components 200 can vary in accordance with design preference, subject as desired to the dimensional restrictions applicable to transport, described above. In this disclosure, structure 150 is fashioned with all sides of equal length; accordingly, its first and second longitudinal edges 106 and 116, and its first and second transverse edges 108 and 110, are all of equal length. It should be understood however, that the inventions described herein are applicable to structures having other dimensions, such as where two opposing wall components 200 are longer than the other two opposing wall components 200.

### B. Partitioned Wall Components

Referring to FIG. 2, structure 150 has two opposing partitioned wall components 200, generically denominate 200s. One of the two opposing partitioned wall components 200s comprises first wall portion 200s-1 and second wall portion 200s-2, and the other of the two opposing partitioned wall components 200s comprises third wall portion 200s-3 and fourth wall portion 200s-4. Each of wall portions 200s-1, 200s-2, 200s-3 and 200s-4 has a generally rectangular planar structure. As shown in FIG. 2, the interior vertical edge 192-1 of wall portion 200s-1 is proximate to a respective interior vertical edge 192-2 of wall portion 200s-2, and the interior vertical edge 194-3 of wall portion 200s-3 is proximate a respective interior vertical wall edge 194-4 of wall portion 200s-4.

Referring again to FIG. 2, first wall portion 200s-1 is fixed in position on floor portion 300a proximate to first transverse edge 108, and third wall portion 200s-3 is fixed in position on floor portion 300a, opposite first wall portion 200s-1 and proximate to second transverse edge 110. First wall portion 200s-1 is joined to second wall portion 200s-2 with a hinge structure that permits wall portion 200s-2 to pivot about vertical axis 192 between a folded position and an unfolded position, and third wall portion 200s-3 is joined to fourth wall portion 200s-4 with a hinge structure to permit fourth wall portion 200s-4 to pivot about vertical axis 194 between a folded position and an unfolded position.

Notably, first wall portion 200s-1 is greater in length (the dimension in the transverse direction) than the length of third wall portion 200s-3 by a distance approximately equal to the thickness of wall component 200, and second wall portion 200s-2 is shorter in length than the length of fourth wall portion 200s-4 by a distance approximately equal to the thickness of wall component 200. Furthermore, wall portion 200s-1 and wall portion 200s-3 are each shorter in length (the dimension in the transverse direction) than the dimension of floor portion 300a in the transverse direction. Dimensioning the lengths of wall portions 200s-1, 200s-2, 200s-3 and 200s-4 in this manner permits wall portions 200s-2 and 200s-4 to nest against each other in an overlapping relationship when in an inwardly folded position. In this regard, FIG. 2 depicts wall portions 200s-2 and 200s-4 both in their unfolded positions, where they are labelled 200s-2u and 200s4-u respectively, and FIG. 2 also depicts wall portions 200s-2 and 200s-4 both in their inwardly folded positions, where they are labelled 200s-2f and 200s4-f respectively. When wall portions 200s-2 and 200s-4 are in their inwardly folded positions (200s-2f and 200s-4f), they facilitate forming a compact shipping module. When wall portion 200s-2 is in its unfolded position (200s-2u), it forms with wall portion 200s-1 a wall component 200s proximate first transverse edge 108, and when wall portion 200s-4 is in its unfolded position (200s-4u), it forms with wall portion 200s-3 a wall component 200s proximate second transverse edge 110.

### C. Unpartitioned Wall Components

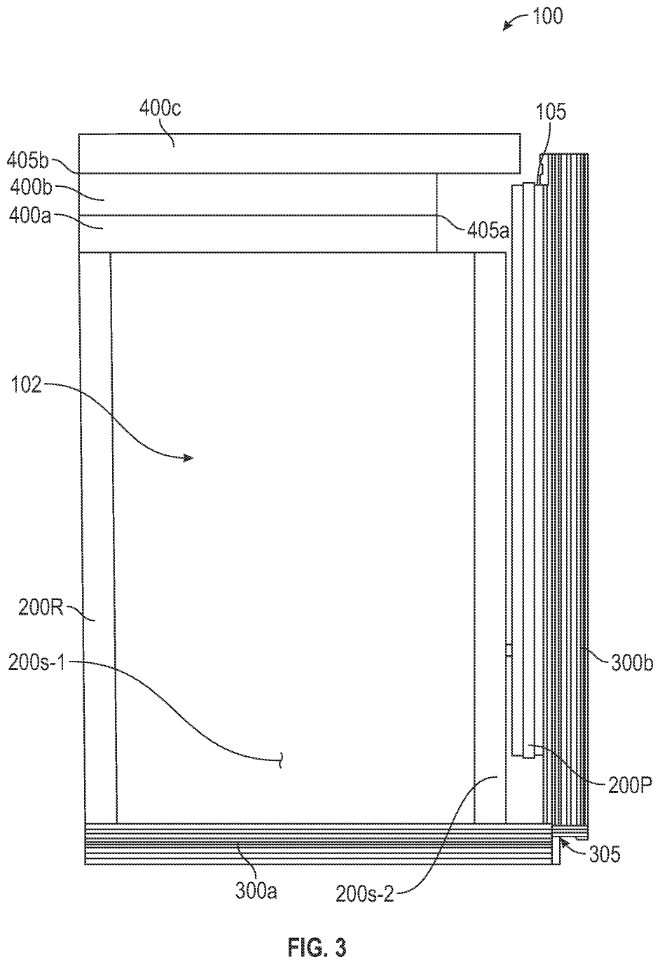

As compared to the two wall components 200 proximate first and second transverse edges 108 and 110, which are partitioned into wall portions, the remaining two wall components 200 proximate first and second longitudinal edges 106 and 116 do not comprise plural wall portions, but rather each is a single piece structure. However, one of these wall components 200, which is sometimes denominated 200P in this disclosure, and which is located on floor portion 300b proximate first longitudinal edge 106, is pivotally secured to floor portion 300b to permit wall component 200P to pivot about horizontal axis 105 shown in FIG. 3 from a folded position to an unfolded position. Pivotally securing wall component 200P also facilitates forming a compact shipping module 15. The remaining wall component 200, sometimes denominated 200R in this disclosure, is rigidly secured on floor portion 300a proximate second longitudinal edge 116 and abutting the vertical edges of first wall portion 200s-1 and third wall portion 200s-3 proximate to second longitudinal edge 116, as shown in FIG. 2.

### D. Wall Component Fabrication

Fabrication of Partitioned Wall Components

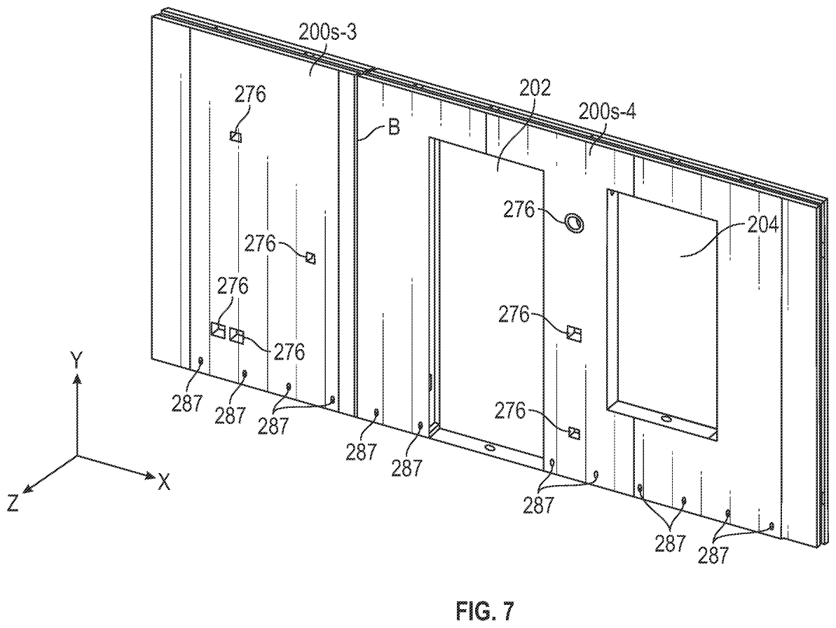

In the structure 150 shown in FIG. 1B, where wall components 200 are six inches (15.2 cm) thick, the partitioned wall components 200s are one foot smaller in length than wall components 200R and 200P. Accordingly, to make a partitioned wall component 200s, a workpiece 250 is subject to the following steps:
(1) Workpiece 250 is moved along the flow path 35 of facility 10 from inspection station 60 to CNC cell 70, where six inches (15.2 cm) of material are vertically cut from each vertical side (Y direction in FIGS. 5 and 7) of the workpiece 250.
(2) Remaining in CNC cell 70, door apertures 202 and window apertures 204 are cut in workpiece 250 as desired, and any electrical, plumbing or other utility access points 276 are cut in workpiece 250 as desired, to yield a workpiece 250 in the state shown in FIG. 7. In addition, if toe screw apertures 287 were not previously formed in first surface layer 210, then pilot holes can be drilled at this point at appropriate locations to assist in locating and forming such toe screw apertures in a subsequent manufacturing stage.
(3) Still in CNC cell 70, the workpiece 250 is cut in the vertical direction (Y direction in FIGS. 7 and 16A) at the appropriate location (in the case of wall portions 200s-3 and 200s-4, along line “B” in FIG. 7) to yield wall portions 200s-1 and 200s-2, or, as shown in FIG. 7, wall portions 200s-3 and 200s-4.
(4) The wall portions 200s-1 and 200s-2, or 200s-3 and 200s-4, are rotated to the vertical position at tilt station 85, following which segments of interior edge reinforcement are positioned and secured (in tilt station 85 and/or work station 90) to the interior edges created in CNC cell 70.
(5) The wall portions are passed through work station 90 to work station 95.
(6) The workpiece 250 is moved from facility 10 and painted, following which any sealing structures, as well as the hinge structures for joining the wall portion 200s-1 with wall portion 200s-2, or for joining wall portion 200s-3 with wall portion 200s-4, can be added, to complete the wall component 200s.

Fabrication of Unpartitioned Wall Components

To make a wall component 200P or a wall component 200R, a workpiece 250 is subject to the following steps:
(1) A workpiece 250 is moved along the flow path 35 of facility 10 from inspection station 60 to CNC cell 70.
(2) Any door apertures 202 and window apertures 204 are cut in workpiece 250 as desired, and any electrical, plumbing or other utility access points are cut in workpiece 250 as desired. In addition, if toe screw apertures 287 were not previously formed in first surface layer 210, then pilot holes can be drilled at this point at appropriate locations to assist in locating and forming such toe screw apertures in a subsequent manufacturing stage.
(3) The workpiece 250 is rotated to the vertical position at tilt station 85, and passed through work station 90 to work station 95.
(4) The workpiece 250 is moved from facility 10 and painted, following which any sealing structures can be added, to complete structure of the wall component 200P or 200R, as the case may be.

### Floor Component (300)

Typically, structure 150 will utilize one floor component 300; thus floor component 300 generally is the full floor of structure 150.

### A. General Description

Floor component 300 has a generally rectangular perimeter and can be fabricated using one or more workpieces 250. The length and width of floor component 300 can vary in accordance with design preference. In the particular embodiment of structure 150 depicted in FIGS. 1B and 2, floor component 300 is approximately 19 feet (5.79 m) by 19 feet (5.79 m).

### B. Floor Partitioning

The floor component 300 is partitioned into floor portion 300a and floor portion 300b. FIG. 2 shows flow portions 300a and 300b in plan view. Each of the floor portions 300a and 300b is a planar generally rectangular structure, with floor portion 300a adjoining floor portion 300b.

Referring to structure 150 shown in FIG. 2, floor portion 300a is fixed in position relative to first wall portion 200s-1, third wall portion 200s-3 and wall component 200R. Floor portion 300a is joined with hinge structures to floor portion 300b, so as to permit floor portion 300b to pivot through approximately ninety degrees (90°) of arc about a horizontal axis 305, generally located as indicated in FIG. 3, proximate the top surface of floor component 300, between a fully folded position, where floor portion 300b is vertically oriented as shown in FIG. 3, and the fully unfolded position shown in FIGS. 2 and 4, where floor portion 300b is horizontally oriented and co-planar with floor portion 300a.

### C. Hinged Vertical Load Transfer Components for Floor Component (300)

FIG. 9A shows a floor beam assembly 325 that can be placed within floor component 300 to provide reinforcement in the direction along the beam and assist in transferring vertical loads borne by floor component 300 to its edges. Floor beam assembly 325 includes two I-beams 326a and 326b. I-beam 326a is positioned approximately in the middle of floor portion 300a, I-beam 326b is positioned approximately in the middle of floor portion 300b, and each of I-beams 326a and 326b is oriented in the transverse direction. A hinge assembly 329A joins I-beam 326a to I-beam 326b. The hinge assembly 329A permits floor beam assembly 325 to be folded to a beam folded position shown in FIG. 9B and unfolded to a beam unfolded position shown in FIG. 9A. The I-beams 326a and 326b extend parallel to the transverse direction in the unfolded position. Further, the hinge assembly 329A can be locked when beam assembly 325 is in the beam unfolded position, which transforms floor beam assembly 325 into a rigid structure that will reinforce floor component 300 in the direction perpendicular to its axis of folding.

Hinge assembly 329A comprises two identical hinge assembly portions 330A partnered together to form a pivoted junction, as shown in FIGS. 9A and 9B. A detailed description of the construction of hinge assembly 329A and its hinge assembly portions 330A is set forth in U.S. Non-Provisional patent application Ser. No. 17/527,520 entitled “Folding Beam Systems”, filed Nov. 16, 2021 and having the same inventors as the subject application. The contents of that U.S. Non-Provisional patent application Ser. No. 17/527,520 entitled “Folding Beam Systems”, filed Nov. 16, 2021 and having the same inventors as the subject application, is incorporated by reference as if fully set forth herein, particularly the description of the construction of hinge assembly 329A and its hinge assembly portions 330A set forth for example in ¶¶0075-0087 and in FIGS. 9-12 and 13C-13E thereof.

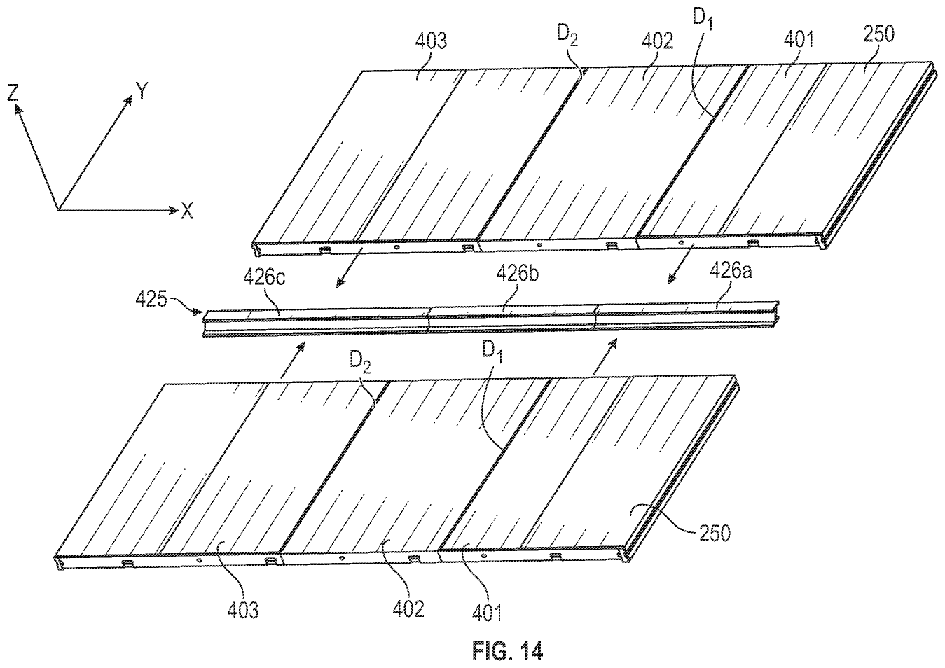

In the embodiment of floor component 300 utilized in the structure 150 of FIGS. 1A-5, floor beam assembly 325 is located at the mid-point between first transverse floor edge 120 and second transverse floor edge 118, and no hinge assemblies 329A are utilized elsewhere within floor component 300, such as proximate to first transverse floor edge 120 and second transverse floor edge 118. Therefore, to assist in smoothly rotating floor portion 300b, there is provided adjacent first transverse floor edge 120 a first floor end hinge assembly 345A joining floor portions 300a and 300b, and there is provided adjacent second transverse floor edge 118 a second floor end hinge assembly 345A joining floor portions 300a and 300b. The locations of both first and second floor end hinge assemblies 345A is indicated in FIG. 10. Floor end hinge assembly 345A comprises two identical floor end hinge portions 350A (not specified in the figures). A description of the construction of floor end hinge assembly 345A and its floor end hinge portions 350A is set forth in U.S. Non-Provisional patent application Ser. No. 17/527,520 entitled “Folding Beam Systems”, filed Nov. 16, 2021 and having the same inventors as the subject application. The contents of that U.S. Non-Provisional patent application Ser. No. 17/527,520 entitled “Folding Beam Systems”, filed Nov. 16, 2021 and having the same inventors as the subject application, is incorporated by reference as if fully set forth herein, particularly the description of the construction of floor end hinge assembly 345A and its floor end hinge portions 350A set forth for example in ¶¶0090-0093 and in FIGS. 14A-14B thereof.

Optionally, floor beam assembly 325 can be provided with apertures at appropriate locations to permit communication between the vertical chases 219W in each of the two workpieces 250. As may be understood, through these apertures there runs a closed path or loop, utility service system 470, generally located about the periphery of roof component 400 and comprising, in addition to major portions of the vertical chases 219W, major portions of the horizontal chases 207 proximate the longitudinal and transverse edges of roof component 400. Utility service system 470 is a pathway through which utility trunk lines can be conveniently routed and connected to service lines, and also provides communication between the two utility service sub-systems 460 in the work pieces 250 of floor component 300.

### D. Floor Component Manufacture

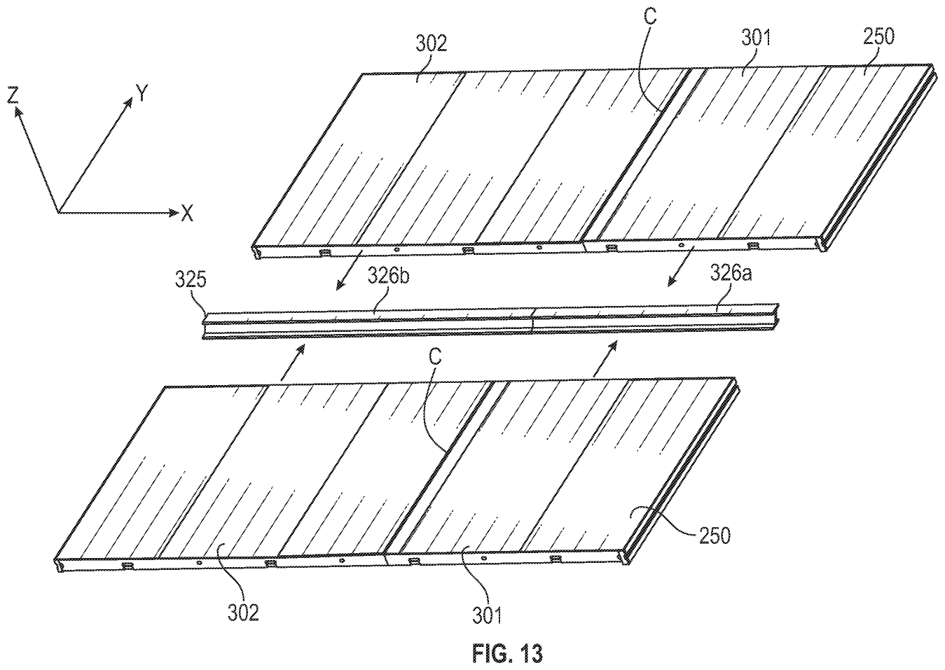

A floor component 300 comprises in substantial part two workpieces 250 joined by a floor beam assembly 325. In fabricating a floor component 300, each workpiece 250 is subject to the following steps:
(1) A workpiece 250 is moved along the flow path 35 of facility 10 from inspection station 60 to CNC cell 70.
(2) In CNC cell 70, any electrical, plumbing or other utility access points are cut in workpiece 250 as desired. In the event that the workpiece 250 has not previously been pre-cut along its appropriate edge to accommodate the profile of the floor beam assembly 325, that operation can also be performed in CNC cell 70.
(3) Remaining in CNC cell 70, the workpiece 250 is cut in the “Y” direction (see FIGS. 5 and 13) at the appropriate location (along line “C” in FIG. 13) to yield two workpiece portions 301 and 302. The transverse dimension of workpiece portion 301 (“X” direction in FIGS. 5 and 13) equals the transverse dimension of floor portion 300a, and the transverse dimension of workpiece portion 302 equals the transverse dimension of floor portion 300b.
(4) The workpiece portions 301 and 302 are moved to tilt station 84, where they are rotated to the vertical orientation. Segments of interior edge reinforcement are then positioned and secured (in tilt station 85 and/or work station 90) to the interior edges created in CNC cell 70.
(5) The workpiece portions 301 and 302 are rotated to the vertical position at tilt station 85, following which segments of interior edge reinforcement are positioned and secured (in tilt station 85 and/or work station 90) to the interior edges created in CNC cell 70.
(6) The workpiece portions 301 and 302 are passed through work station 90 to work station 95.
(7) The workpiece portions 301 and 302 are moved from facility 10 and painted, following which any sealing structures can be added.
(8) The workpiece portions 301 and 302 are then positioned as shown in FIG. 13, and joined to a floor beam assembly 325 to complete floor component 300.

### Roof Component (400)

Typically, structure 150 will utilize one roof component 400; thus roof component 400 generally is the full roof of structure 150.

### A. General Description

Roof component 400 has a generally rectangular perimeter and can be fabricated using one or more workpieces 250. FIG. 1B depicts roof component 400. The length and width of roof component 400 can vary in accordance with design preference. In the particular embodiment of structure 150 depicted in FIGS. 1B, 4 and 5, the length and width of roof component 400 approximates the length and width of floor component 300.

### B. Roof Partitioning

The roof component 400 of structure 150 is partitioned into roof portions 400a, 400b and 400c, shown in FIGS. 1A and 3 when folded, and in FIG. 1B when unfolded. Each of the roof portions 400a, 400b and 400c is a planar generally rectangular structure, with roof portion 400a adjoining roof portion 400b, and roof portion 400b adjoining roof portion 400c.

In the shipping module 15 shown in FIGS. 1A and 3, roof portions 400a, 400b and 400c preferably are accordion folded (stacked), with roof component 400b stacked on top of roof component 400a, and roof component 400c stacked on top of the roof component 400b. As can be appreciated from FIG. 3, roof portion 400a is fixed in position relative to first wall portion 200s-1, third wall portion 200s-3 and wall component 200R. Thus to realize the accordion folded configuration shown in FIG. 3, roof portion 400a is joined to roof portion 400b with hinge structures that are adapted to permit roof portion 400b to pivot through up to one hundred and eighty degrees (180°) of arc about a horizontal axis 405a (see FIG. 3) between the roof fully folded position shown in FIGS. 1A and 3, where roof portion 400b lies stacked flat against roof portion 400a, and the fully unfolded position shown in FIG. 1B. In turn, roof portion 400b is joined to roof portion 400c with hinge structures that are adapted to permit roof portion 400c to pivot through up to one hundred and eighty degrees (180°) of arc about a horizontal axis 405b (see FIG. 3) between the fully folded position shown in FIGS. 1A and 3, where roof portion 400c lies stacked flat against roof portion 400b (when roof portion 400b is positioned to lie flat against roof portion 400a), and the fully unfolded position shown in FIG. 1B.

### C. Hinged Vertical Load Transfer Components for Roof Component (400)

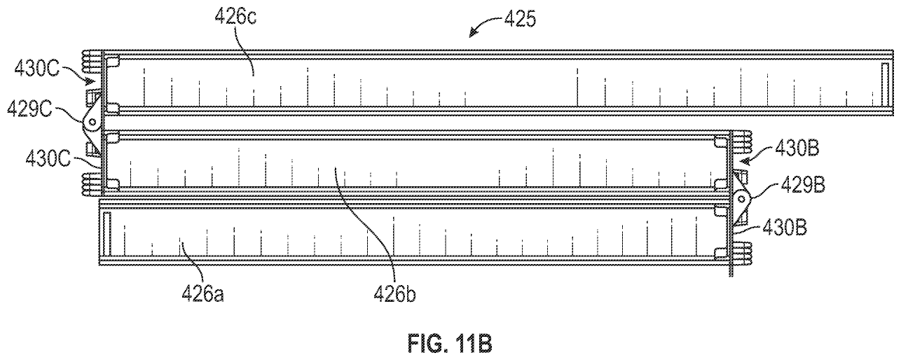

FIGS. 11A and 11B shows a roof beam assembly 425 that can be placed within roof component 400 to provide reinforcement in the direction along the beam and assist in transferring vertical loads borne by floor component 300 to its edges. Roof beam assembly 425 includes three I-beams 426a, 426b and 426c. A hinge assembly 429B joins I-beam 426a to I-beam 426b. In addition, a hinge assembly 429C joins I-beam 426b to I-beam 426c. The hinge assemblies 429B and 429C permit roof beam assembly 425 to be folded to a beam folded position, shown in FIG. 11B, and unfolded to a beam unfolded position, shown in FIG. 11A. The I-beams 426a and 426b and 426c extend parallel to the transverse direction in the unfolded position. Further, the hinge assemblies 429B and 429C can be locked when roof beam assembly 425 is in the beam unfolded position, which transforms roof beam assembly 425 into a rigid structure that will reinforce roof component 400 in the direction perpendicular to its axes of folding.

Hinge assembly 429B comprises two identical hinge assembly portions 430B partnered together to form a pivoted junction, and hinge assembly 429C comprises two identical hinge assembly portions 430C partnered together to form a pivoted junction. A detailed description of the construction of these hinge assemblies and their hinge assembly portions is set forth in U.S. Non-Provisional patent application Ser. No. 17/527,520 entitled “Folding Beam Systems”, filed Nov. 16, 2021 and having the same inventors as the subject application. The contents of that U.S. Non-Provisional patent application Ser. No. 17/527,520 entitled “Folding Beam Systems”, filed Nov. 16, 2021 and having the same inventors as the subject application, is incorporated by reference as if fully set forth herein, particularly the description of the construction of hinge assembly 429B and its hinge assembly portions 430B set forth for example in ¶¶00106-00118 and in FIGS. 16-19 and 24A thereof, and the description of the construction of hinge assembly 429C and its hinge assembly portions 430C set forth for example in ¶¶00119-00126 and in FIGS. 20-23 and 24A-24B thereof.

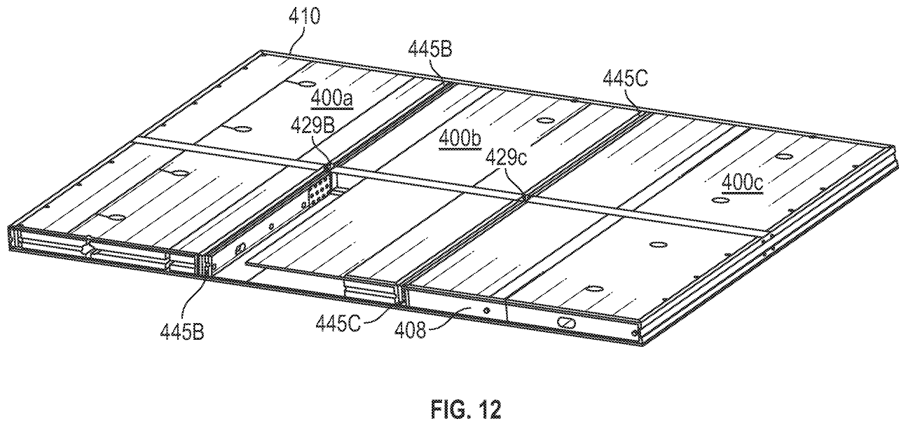

In the embodiment of roof component 400 shown in the figures, roof beam assembly 425 is located at the mid-point between first transverse roof edge 408 and second transverse roof edge 410, and no hinge assemblies 429B or 429C are utilized elsewhere within roof component 400, such as proximate to first transverse roof edge 408 or second transverse roof edge 410. Therefore, to assist in smoothly rotating roof portion 400b relative to roof portion 400a, there is provided adjacent first transverse roof edge 408 a first roof end hinge assembly 445B joining roof portions 400a and 400b, and there is provided adjacent second transverse roof edge 410 a second roof end hinge assembly 445B joining roof portions 400a and 400b. Additionally, to assist in smoothly rotating roof portion 400c relative to roof portion 400b, there is provided adjacent first transverse roof edge 408 a first roof end hinge assembly 445C joining roof portions 400b and 400c, and there is provided adjacent second transverse roof edge 410 a second roof end hinge assembly 445C joining roof portions 400b and 400c. The locations of first and second roof end hinge assemblies 445B are indicated in FIG. 12, and the locations of first and second roof end hinge assemblies 445C are indicated in FIG. 12.

Roof end hinge assembly 445B comprises two identical roof end hinge portions 450B, and roof end hinge assembly 445C comprises two identical roof end hinge portions 450C (roof end hinge portions 450B, 450C are not specified in the figures). A description of the construction of these roof end hinge assemblies and roof end hinge portions is set forth in U.S. Non-Provisional patent application Ser. No. 17/527,520 entitled “Folding Beam Systems”, filed Nov. 16, 2021 and having the same inventors as the subject application. The contents of that U.S. Non-Provisional patent application Ser. No. 17/527,520 entitled “Folding Beam Systems”, filed Nov. 16, 2021 and having the same inventors as the subject application, is incorporated by reference as if fully set forth herein, particularly the description of the construction of roof end hinge assembly 445B and its roof end hinge portions 450B set forth for example in ¶¶00127-00130 and in FIGS. 25A-25B thereof, and the description of the construction of roof end hinge assembly 445C and its roof end hinge portions 450C set forth for example in ¶¶00131-00132 and in FIGS. 24B and 25D thereof.

Optionally, roof beam assembly 425 can be provided with apertures as appropriate locations to permit communication between the vertical chases 219W in each of the two workpieces 250. As may be understood, through these apertures there runs a closed path or loop, utility service system 470, generally located about the periphery of roof component 400 and comprising, in addition to major portions of the vertical chases 219W, major portions of the horizontal chases 207 proximate the longitudinal and transverse edges of roof component 400. Utility service system 470 is a pathway through which utility trunk lines can be conveniently routed and connected to service lines, and also provides communication between the two utility service sub-systems 460 in the work pieces 250 of roof component 400.

### D. Roof Component Manufacture

A roof component 400 comprises in substantial part two workpieces 250 joined by a roof beam assembly 425. In fabricating a floor component 400, each workpiece 250 is subject to the following steps:
(1) A workpiece 250 is moved along the flow path 35 of facility 10 from inspection station 60 to CNC cell 70.
(2) In CNC cell 70, any electrical, plumbing or other utility access points are cut in workpiece 250 as desired. In the event that the workpiece 250 has not previously been pre-cut along its appropriate edge to accommodate the profile of the roof beam assembly 425, that operation can also be performed in CNC cell 70.
(3) Still in CNC cell 70, the workpiece 250 is cut in the “Y” direction (see FIGS. 5 and 14) at appropriate locations (along lines “D₁” and “D₂” in FIG. 14) to yield three workpiece portions 401, 402 and 403. The width of workpiece portion 401 (“X” direction in FIGS. 5 and 14) equals the width of roof portion 400a, the width of workpiece portion 402 equals the width of roof portion 400b and the width of workpiece portion 403 equals the width of roof portion 400c.
(4) The workpiece portions 401, 402 and 403 are moved to tilt station 85, and then rotated to the vertical position. Segments of interior edge reinforcement are then positioned and secured (in tilt station 85 and/or work station 90) to the interior edges created in CNC cell 70.
(5) The workpiece portions 401, 402 and 403 are passed through work station 90 to work station 95.
(6) The workpiece portions 401, 402 and 403 are moved from facility 10 and painted, following which any sealing structures can be added.
(7) The workpiece portions 401, 402 and 403 are then positioned as shown in FIG. 14, and joined to a roof beam assembly 425 to complete roof component 400.

### Fixed Space Portion Build-Out and Finishing

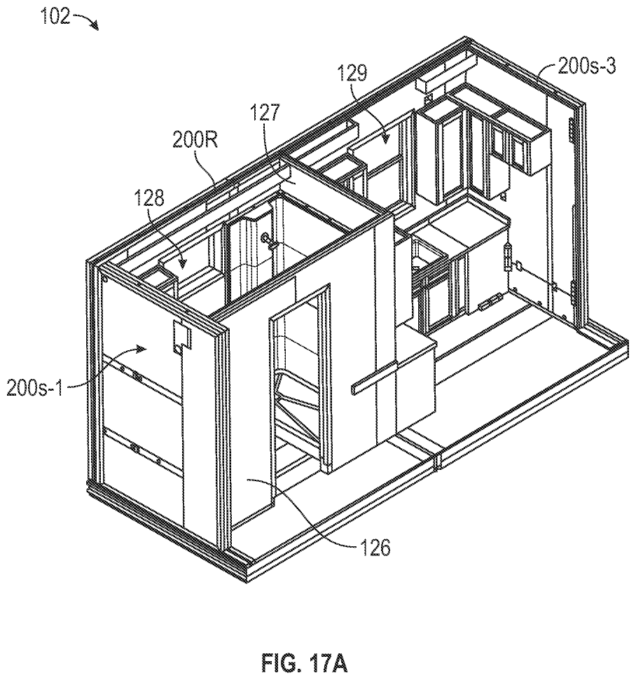

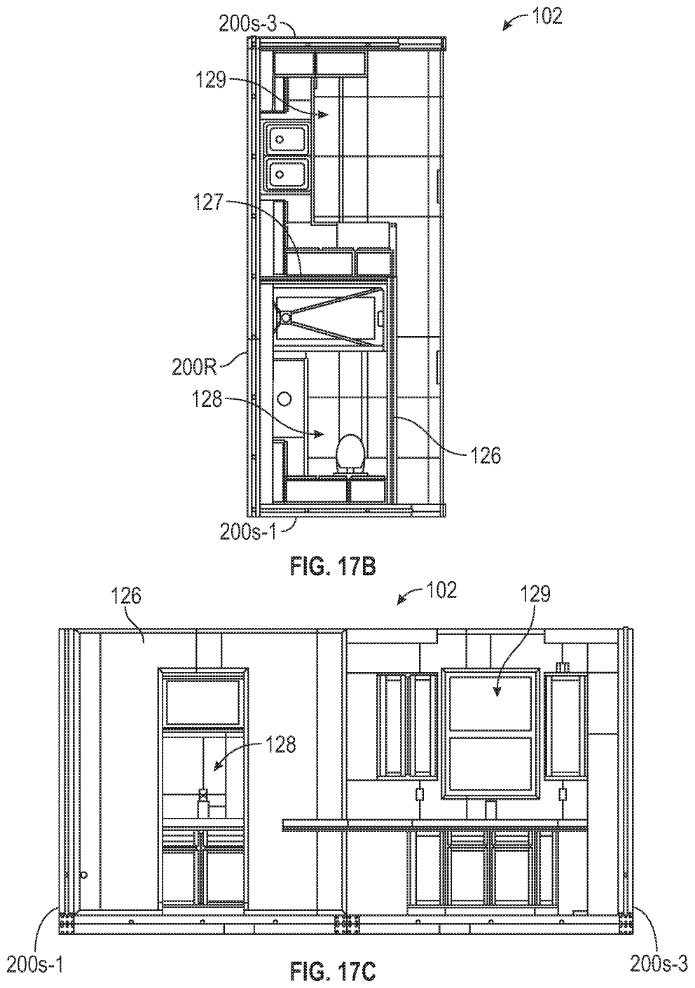

Referring to FIGS. 2 and 17A-17C, structure 150 includes a fixed space portion 102 defined by roof component 400a (shown in FIG. 3), floor component 300a, wall component 200R, wall portion 200s-1 and wall portion 200s-3. (Fixed space portion 102 is also shown edge-on in the shipping module 100 depicted in FIG. 3). It is preferred that the fixed space portion 102 be fitted out during manufacture with internal components, such as kitchens, bathrooms, closets, storage areas, corridors, etc., so as to be in a relatively finished state prior to shipment of shipping module 100.

For example, interior walls 125 can be put into fixed space portion 102 during manufacture as desired. Referring to FIGS. 2 and 17A-17C, there is shown two interior walls 125, specifically a longitudinal interior wall 126 and a transverse interior wall 127. Interior walls 125 each can comprise a foam panel layer, for example three inches (3″) thick, with building panels such as cement board approximately 0.25 inch (6 mm) thick fastened to each face of the foam panel using a suitable adhesive, preferably a polyurethane based construction adhesive.

As shown for example in FIG. 17A, a first vertical edge of longitudinal interior wall 126 abuts wall portion 200s-1, and a first vertical edge of transverse interior wall 127 abuts wall component 200R. The second vertical edge of transverse wall portion 127 abuts the longitudinal interior wall 126 proximate to the latter's second vertical edge, such that interior walls 126 and 127, with wall component 200R and wall portion 200s-1, form a rectangular enclosed area that, in the embodiment shown in FIGS. 2 and 17A-17C, is a bath room 128. In the embodiment shown, bath room 128 is fitted out during manufacture to include a shower enclosure, a toilet and a wash sink.

The open area between transverse interior wall 127 and wall portion 200s-3 in the embodiment shown in FIGS. 2 and 17A-17C is a kitchen area 129. In the embodiment shown in FIGS. 17A-17C, kitchen area 129 is fitted out during manufacture to include cabinets, countertops and cooking facilities.

Also, in the embodiment shown in FIGS. 1B and 2, wall components 200 are fitted during manufacture and prior to shipment with all necessary door and window assemblies, with the enclosure components 155 being pre-wired for electrical needs.

### Enclosure Component Relationships and Assembly for Transport

It is preferred that there be a specific dimensional relationship among enclosure components 155.

Roof portions 400a, 400b and 400c each can be identically dimensioned in the transverse direction. Alternatively, referring to FIG. 3, roof portion 400c can be dimensioned to be larger than either of roof portion 400a and roof portion 400b in the transverse direction to reduce the chances of binding during the unfolding of roof portions 400b, 400c. Further specifics on dimensioning roof portion 400c in the foregoing manner are described in U.S. Non-Provisional application Ser. No. 17/569,962, entitled “Improved Folding Roof Component,” filed on Jan. 6, 2022. In addition, as described in U.S. Nonprovisional patent application Ser. No. 16/786,315, entitled “Equipment and Methods for Erecting a Transportable Foldable Building Structure,” filed on Feb. 10, 2020 and now U.S. Pat. No. 11,220,816, as well as in U.S. Non-Provisional application Ser. No. 17/569,962 mentioned above, friction-reducing components can be used to facilitate unfolding roof component 400, such as by positioning a first wheel caster at the leading edge of roof portion 400c proximate to the corner of roof portion 400c that is supported by wall portion 200s-2 as roof portion 400c is deployed, and by positioning a second similar wheel caster at the leading edge of roof portion 400c proximate to the corner of roof portion 400c that is supported by wall portion 200s-4 as roof portion 400c is deployed.

Accordingly, in the preferred embodiment each of roof portions 400a and 400b is approximately 4 E long and 1.25 E wide, whereas roof portion 400c is approximately 4 E long and 1.45 E wide. In FIGS. 2 and 3, each of floor components 300a and 300b is 4 E long; whereas floor component 300a is just over 1.5 E wide and floor component 300b is just under 2.5 E wide. Wall components 200P and 200R are approximately 4 E long, whereas each of wall components 200s in the preferred embodiment is approximately 4 E long, less the combined thicknesses of wall components 200P and 200R, as previously indicated.

As shown in FIG. 2, fourth wall portion 200s-4 is folded inward and positioned generally against fixed space portion 102, and second wall portion 200s-2 is folded inward and positioned generally against fourth wall portion 200s-4 (wall portions 200s-2 and 200s-4 are respectively identified in FIG. 2 as portions 200s-2f and 200s-4f when so folded and positioned). The three roof components 400a, 400b and 400c are shown unfolded in FIG. 1B and shown folded (stacked) in FIGS. 1A and 3, with roof component 400b stacked on top of roof component 400a, and roof component 400c stacked on top of the roof component 400b. Wall component 200P, shown in FIGS. 2 and 3, is pivotally secured to floor portion 300b at the location of axis 105 (the general location of which is shown in FIG. 3), and is vertically positioned against the outside of wall portions 200s-2 and 200s-4. In turn, floor portion 300b is vertically positioned proximate fixed space portion 102, with wall component 200P pending from floor portion 300b between floor portion 300b and wall portions 200s-2 and 200s-4.

Sizing the enclosure components 155 of structure 150 according to the dimensional relationships disclosed above yields a compact shipping module 15, as can be seen from the figures. Thus shipping module 15 depicted in FIGS. 1A and 3, when dimensioned according to the relationships disclosed herein using an “E” dimension (see FIG. 2) of 57 inches (144.8 cm), and when its components are stacked and positioned as shown in FIG. 3, has an overall length of approximately 19 feet (5.79 m), an overall width of approximately 8.5 feet (2.59 meters) and an overall height of approximately 12.7 feet (3.87 meters). These overall dimensions are less than a typical shipping container.

Each of the wall, floor and roof components 200, 300 and 400, and/or the portions thereof, can be sheathed in protective film 177 during fabrication and prior to forming the shipping module 15. Alternatively or in addition, the entire shipping module 15 can be sheathed in a protective film. Such protective films can remain in place until after the shipping module 15 is at the construction site, and then removed as required to facilitate enclosure component deployment and finishing.

### Shipping Module Transport

The shipping module 15 is shipped to the building site by appropriate transport means. One such transport means is disclosed in U.S. Non-Provisional application Ser. No. 16/143,628, filed Sep. 27, 2018 and now U.S. Pat. No. 11,007,921, issued May 18, 2021; the contents of that U.S. Non-Provisional application Ser. No. 16/143,628, filed Sep. 27, 2018 are incorporated by reference as if fully set forth herein, particularly as found at paragraphs 0020-0035 and in FIGS. 1A-2D thereof. As an alternative transport means, shipping module 15 can be shipped to the building site by means of a conventional truck trailer or a low bed trailer (also referred to as a lowboy trailer), and in the case of over-the-water shipments, by ship.

### Structure Deployment and Finishing

At the building site, shipping module 15 is positioned over its desired location, such as over a prepared foundation; for example, a poured concrete slab, a poured concrete or cinder block foundation, sleeper beams or concrete posts or columns. This can be accomplished by using a crane, either to lift shipping module 15 from its transport and move it to the desired location, or by positioning the transport means over the desired location, lifting shipping module 15, then moving the transport means from the desired location, and then lowering shipping module 15 to a rest state at the desired location. Particularly suitable equipment and techniques for facilitating the positioning of a shipping module 15 at the desired location are disclosed in U.S. Non-Provisional patent application Ser. No. 16/786,315, entitled “Equipment and Methods for Erecting a Transportable Foldable Building Structure,” and filed on Feb. 10, 2020, now U.S. Pat. No. 11,220,816. The contents of that U.S. Non-Provisional patent application Ser. No. 16/786,315, entitled “Equipment and Methods for Erecting a Transportable Foldable Building Structure,” and filed on Feb. 10, 2020, are incorporated by reference as if fully set forth herein, particularly including the equipment and techniques described for example at ¶¶126-128 and in connection with FIGS. 11A and 11B thereof.

Following positioning of shipping module 15 at the building site, the appropriate portions of wall, floor and roof components 200, 300 and 400 are “unfolded” (i.e., deployed) to yield structure 150. Unfolding occurs in the following sequence: (1) floor portion 300b is pivotally rotated about horizontal axis 305 (shown in FIG. 3) to an unfolded position, (2) wall component 200P is pivotally rotated about horizontal axis 105 (see FIG. 3) to an unfolded position, (3) wall portions 200s-2 and 200s-4 are pivotally rotated about vertical axes 192 and 194 (shown in FIG. 2) respectively to unfolded positions, and (4) roof portions 400b and 400c are pivotally rotated about horizontal axes 405a and 405b (shown in FIG. 3) respectively to unfolded positions.

After unfolding, the enclosure components 155 are secured together to finish the structure 150 that is shown in FIG. 1B. During or after unfolding and securing of the enclosure components 155, any remaining finishing operations are performed, such as addition of roofing material, and making hook-ups to electrical, fresh water and sewer lines to complete structure 150, as relevant here.

This disclosure should be understood to include (as illustrative and not limiting) the subject matter set forth in the following numbered clauses:

Clause 1. A build-up cell comprising:
a rectangular foam assembly ready table for receiving a foam layer assembly;
a rectangular staging table for receiving a first surface panel arrangement;
a rectangular assembly bed for receiving a second surface panel arrangement from a first direction and delivering a superposed lamination assembly in a second direction parallel to the first direction;
the foam assembly ready table positioned proximate to the assembly bed on a first side thereof, and the surface assembly ready table positioned proximate to the assembly bed on a second side thereof opposite to the first side thereof;
an adhesive gantry straddling the assembly bed and moveable across the assembly bed in a third direction parallel to the first direction;
a first lifter moveable in the horizontal direction between a first position above the foam assembly ready table and a second position above the assembly bed, and moveable in the vertical direction, to thereby engage a foam layer on the foam assembly ready table and lift to the first position, move it from the first position to the second position, and place it on a second surface panel arrangement on the assembly bed;
a second lifter moveable in the horizontal direction between a third position above the staging table and a fourth position above the assembly bed, and moveable in the vertical direction, to thereby engage a first surface panel arrangement on the staging table and lift it to the third position, move it from the third position to the fourth position, and place it on a foam layer positioned on the assembly bed.

Clause 2. The build-up cell of clause 1, wherein the first and second directions are colinear.

Clause 3. The build-up cell of clause 1, wherein the second and fourth positions are the same.

Clause 4. The build-up cell of clause 1, wherein the first lifter is linearly moveable in the horizontal direction between the first position above the foam assembly ready table and the second position above the assembly bed.

Clause 5. The build-up cell of clause 1, wherein the second lifter is linearly moveable in the horizontal direction between the third position above the foam assembly ready table and the fourth position above the assembly bed.

The foregoing detailed description is for illustration only and is not to be deemed as limiting the inventions disclosed herein, which are defined in the appended claims.

What is claimed is:

1. A build-up cell, comprising:
a rectangular foam assembly ready table for receiving a foam layer assembly;
a rectangular panel assembly ready table for receiving a first surface panel arrangement;
a rectangular assembly bed for receiving a second surface panel arrangement from a first direction and delivering a superposed lamination assembly in a second direction parallel to the first direction;
the foam assembly ready table positioned proximate to the assembly bed on a first side thereof, and the surface assembly ready table positioned proximate to the assembly bed on a second side thereof opposite to the first side thereof;
an adhesive gantry straddling the assembly bed and moveable across the bed in a third direction parallel to the first direction;
a first lifter moveable in the horizontal direction between a first position above the foam assembly ready table and a second position above the assembly bed, and moveable in the vertical direction, to thereby engage a foam layer assembly on the ready table and lift it to the first position, move it from the first position to the second position, and place it on a second surface panel arrangement on the assembly bed; and
a second lifter moveable in the horizontal direction between a third position above the surface assembly ready table and a fourth position above the assembly bed, and moveable in the vertical direction, to thereby engage a first surface panel arrangement on the surface assembly ready table and lift it to the third position, move it from the third position to the fourth position, and place it on a foam layer positioned on the assembly bed.

2. The build-up cell of claim 1, wherein the first and second directions are colinear.

3. The build-up cell of claim 1, wherein the second and fourth positions are the same.

4. The build-up cell of clause 1, wherein the first lifter is linearly moveable in the horizontal direction between the first position above the foam assembly ready table and the second position above the assembly bed.

5. The build-up cell of claim 1, wherein the second lifter is linearly moveable in the horizontal direction between the third position above the foam assembly ready table and the fourth position above the assembly bed.

6. The build-up cell of claim 1, wherein the rectangular panel assembly ready table includes rollers for movement of the first surface panel arrangement thereon.

7. The build-up cell of claim 1, wherein the rectangular assembly bed includes rollers for movement of the second surface panel arrangement thereon.

8. The build-up cell of claim 1, wherein the adhesive gantry includes downward-directed nozzles.

9. The build-up cell of claim 8, wherein the downward-directed nozzles are configured to deposit an extrusion of adhesive onto items placed on the assembly bed.

10. The build-up cell of claim 9, wherein the adhesive is water activated polyurethane construction adhesive.

11. The build-up cell of claim 9, wherein the adhesive gantry includes water misters configured to spray a mist to activate the extruded adhesive.

12. The build-up cell of claim 1, wherein the first lifter is a vacuum lifter, a mechanical lifter, or a combination thereon.

13. The build-up cell of claim 1, wherein the second lifter is a vacuum lifter, a mechanical lifter, or a combination thereof.

14. The build-up cell of claim 1, comprising a press table.
